(19) United States
(12) Patent Application Publication
(10) Pub. No.: US 2010/0161231 A1
(43) Pub. Date: Jun. 24, 2010

(54) Earthquake, ground water, mine, oil, space detection system

(76) Inventor: Abdulaziz Atila, Elazig (TR)

Correspondence Address: Oppedahl Patent Law Firm LLC, P O Box 5940, Dillon, CO, 80435-5940, US

(21) Appl. No.: 12/670,180

(22) PCT Filed: Jul. 30, 2008
(86) PCT No.: PCT/IB08/53061

§ 371 Date: Jan. 22, 2010

(30) Foreign Application Priority Data
Aug. 1, 2007 (TR) 2007/05348

(51) Int. Cl. G01V 1/28

(52) U.S. Cl. 702/15

(57) ABSTRACT

This system is based on the measurement of the electrical and magnetic waves emitted by the system which is being measured. Geological faults, ground waters, mines, treasures, oil reservoirs are detected by this system. Earthquakes are predicted. Artificial earthquake waves are triggered. The system is used as radar. Currents of human body, animals, plants are measured. Structures of the ground of the world and of the planets are elucidated. Electrical and magnetic structures of the earth and celestial bodies are determined. Wave shapes of materials and of the living are determined. This system comprises measuring rods (4) and bows (3), coils wound around rods and bows, ammeter (19), current controller (20), electronic brain (25), electronic circuit (26), sensors (29), computer (27), telescope (75), small and big diameter cable networks, systems for activating the telescope and antennas.

The present invention relates to detecting geological faults; predicting earthquakes in advance; generating artificial earthquakes; searching for and detecting ground waters; searching for and detecting mines; searching for oil and detecting oil reservoirs; measuring electrical and magnetic fields of the moon, sun, planets, stars and galaxies and obtaining surface images thereof; elucidating geological structures of the planets; measuring currents of human brain and body and using these data in the field of medicine; detecting treasures underground and historical remains, measuring current values of plants, measuring the waves emitted by flying objects and using these data as radar system; elucidating chemical structures of rocks and minerals; using the data obtained with this system for communication purposes.

Measuring Device and System

The measuring apparatus comprises parts like ammeter, measuring rods and their sets in pairs, one measuring bow and its sets, magnet wires coiled around rods, current controller, power supply, bearings for measuring rods, pendulums or a spring system which enable the rods to remain in balance, connection cables, measuring cable and nails, on/off switch to yield current, direction tray, compensation coils. These are the main parts. In addition to these, there are auxiliary equipments for automatic measurement of the system according to the place of use and purpose, including electronic or electromechanical automatic current controller, electronic brain that controls the automatic current controller, sensors that send signals to the electronic brains, electronic circuit that transmits the current value to be read at the ammeter and a computer that saves the data and draws the required graphics, activation systems, targeting nails and antennas and a network of a very large diameter measuring cable.

The said device is based on measurement of the electrical and magnetic waves emitted by the measured system. These waves create an electrical and magnetic field around them, carry high amount of energy, diffuse in air, space, ground, water and all kinds of mines, flows through a conductor like an electric current if necessary and is not affected by distance.

Main Parts of the Device

1. Measuring Rods

Measuring rods are made of any kind of metal, metal alloys, graphite, wood or any material that has the feature of electrification. One end of the measuring rod is free to move right/left, the other end is connected to a shaft or bearing or held by hand and the rod is rotatable 360 degrees around the axis of the point it is connected to or held. The rods are shaped in different forms (rod, fin, bow, ring, disc or flat) as seen in FIGS. 1, 2, 3, 4, 5, 6. Although shaping of the rods is not limited to these, shapes of the rods do not change the results of the measurements. Lengths and diameters of the rods are set in different sizes according to the place of use. During measurement, the rods are either carried by hand or by mounting on suitable bearings. The rods given in FIG. 4 are carried and moved on a fixed shaft. If the rods are mounted on the bearings, weights (2) are connected to their rear parts to balance the weight of the rod and the coil to be wound thereon.

Magnet wires (3) are wound around the rods. In addition to the coils being wound close to the end portion of the rods, they are also wound around the entire rod or around the handles (1) of the rods. The coils (3) can be wound longitudinally (5) as well as transversely. The current passing through the circuit and the distance between the rods is more important than the winding form of the coils. The number of winding turns of the coil and the section of the wire to be used are adjusted according to the current to be drawn. In cases where small amount of current will be drawn, thin section coil wire and less winding will be sufficient. In cases where a large amount of the current will be drawn, wide section coil wire is used and many parallel windings are carried out. Moreover, different sets of pairs of rods are prepared with different windings, because in cases where the current increases, coils with more winding are needed. Ends of the coil wires are extended to the bottom of the rods as seen in FIG. 7 and inputs and outputs are connected to different cables (6). Then the cables of the two rods are connected in parallel (8) to each other. Series connection can also be performed here, but as the parallel connection provides the opportunity of drawing much current in low voltage, parallel connection is more suitable. The portions of the cables connected to the coils are isolated and connected to the rods. Since if the connection cables are too thick they will impede movement of the rods due to their tension, the rods are made of a tubular material. The ends of the coil wires are passed through a tube as in FIG. 8 and connected to the connection cables (6) from under the handle (1) parts of the rods. In fact, the ends of the coil wires are connected to the conductive coals (12) and these coals, by rubbing against the conductive tray (13), rotate and receive the current. Thus the tension caused by the cables is reduced. Current is provided to the coils of the rods from different sources, but in this case a separate current controller and separate ammeters are needed for each source and control of the current gets more difficult. For that reason feeding from a single source is more appropriate. The point that should be paid attention to here is to ensure that the coil wires wound up to both of the rods and the connection cables are of the same diameter and length. In other words, if the resistances of both of the coils are of the same value, the current is distributed evenly to both of the branches. Instead of the coil wires, magnets are also connected to the ends of the rods so as to repel each other. Measurements are also made by magnets, or parallel cables are connected to rods or rods are made of thick cables. Measurements can also be carried out by passing a strong current over these cables. But the easiest measurements are performed via coils. Measurement rods are shown in FIG. 9 schematically. These schematic figures will be used in measurement drawings.

2. Ammeter:

The ammeter is used when measurements are made with the purpose of determining the current used in measurement. The ammeter is connected in series between the measurement rods, current controller and power supply. Multi-purpose multimeters and clampmeters are also used for the same purpose.

3. Current Controller

Both DC and AC currents are used in the system, however since there is a difficulty of providing AC current in land conditions, generally DC current is preferred. A current controller is needed in order to be able to adjust strength of current and fix it to certain values. For this purpose, rheostats, variacs or electronic current controllers which are resistant to the current amounts to be used, are employed. As sometimes there are vast fluctuations between the current changes, several current controllers which are resistant to different ampere ranges are connected to the device.

4. Power Supply

Batteries or accumulators are used as the power supply. Where the measurement point is fixed, DC current transformers and AC current transformers are also used.

5. Bearings

Suitable bearings are used, to which handles (1) of the rods will be mounted and which will allow the rods to easily turn right/left therein. Bearings are produced precisely and in such a way so as to reduce friction losses as much as possible. Furthermore in order for the bearings to reach balance in all conditions, it may be ensured that they turn right, left, upward, downward and this should be done adjustably. In order to monitor the balance status, horizontal and vertical water gauges are mounted. Some examples of the bearings (9) are given in FIGS. 8 and 10 schematically. Additionally, pendulums or springs (10) are mounted to the handles (1) of the rods which keep the rods in balance (Very thin and light springs are used here. If they impede movement of the rods, they may not be used). However, where the rods are used mounted to the bearings, when current is supplied to the coils, an electrical and magnetic field and in connection with that eddy currents can be generated between the rods and bearings. These factors make the movement of the rods difficult. This situation causes errors in measurements. In order to eliminate this problem, friction surfaces are reduced as much as possible. When necessary, a field is generated, around the bearings, which stabilizes the electrical and magnetic field formed by the rods. Bearings are needed when a fixed measurement station is established somewhere and for making the measurements persistent.

Normally, the measurements are performed by carrying the rods in hand. If the rods are carried in hand, there will be no need for bearings, counterweights or springs. In this case, the user takes the handles (1) of the rods in between her/his fingers (17). S/he neither clenches her/his fingers nor releases them. S/he keeps the rods horizontal to the floor, in a balanced manner. Here the hand both serves as a bearing and balances the tensions originating from the weights of the coils and the connection cables on the rod. Here the human hand has other functions too. The magnetic field of the human body generates a current on the rods; when the rods enter the magnetic and electrical field of the place or material that is measured, the magnetic field creates a torque effect on this current. Or, the magnetic field of the measured system generates a current on the rods. When this current passes through the magnetic field of the hand, magnetic field of the hand generates a toque effect on the rods. Thus movement of the rods is enabled. Additionally, it is a physically known truth that + and − charge distribution occurs on the conductors which enter an electrical field vertically (FIG. 13) (This charge distribution is not a new information, it is provided only to facilitate understanding of the invention). Since normally this charge distribution is homogenous on the rods, the rods draw each other from any and all directions in the same ratio thus in this case there is no movement observed in the rods. The electrical and magnetic field created by the human body concentrates these charges towards the end portion of the rods and enables movement thereof. For these reasons, when the rods are carried in hand more reliable measurements are carried out in comparison with bearings.

6. Portable Table

It is a table on which the parts of the device are to be mounted, and which is easily portable, can be dismantled and is made of a lightweight material. The parts of the device, excluding the measuring rods are also mounted to a box. Then the measuring rods are connected to the device via cables.

7. Connection Cables

They are isolated cables which provide connection between the power supply and the current controller, and between the ammeter and the measuring rods. The diameters and the lengths of these cables are adjusted according to the current and place of use.

8. Switch

It is the on/off switch for providing current from the battery, accumulator or transformer to the circuit.

9. Measuring Cables and Nails

Measuring cables and nails are especially used for measuring depth in searches for ground water, mines and oil. Additionally they are used in determining direction of the earthquake waves; measuring electrical and magnetic fields of the sun, moon, planets, stars and galaxies; use of the device as a radar and in clarification of the structure of the ground. For this reason, preferably lightweight cables with thin diameters, which are easily portable in land conditions, are used. When necessary, the cables are connected to each other and the connection points are isolated and elongated. A stake or a nail made of metal is driven in at the point where the measurement will be carried out. One end of the cable is connected to this nail or stake and the cable is properly laid on the land. The other end of the cable is isolated. It is of no importance from which metal the cable is made of. It may be made of any kind of metal or alloy. Additionally, coil wires and fiber optic cables are also used. With the same purpose, wires and wet ropes are also used, but since these will receive electricity from different points upon contacting the ground, they may cause erroneous results. Moreover, a thin hose is filled with water; a conductive wire is immersed within the water in the hose from one end of the hose, it is closed with a stopper or by wrapping around a tape to prevent water leakage, then it is connected to the conductive measuring nail. The other end of the hose is also closed. This hose is laid on the land like the cable and it is used for the same purpose.

Cables or hoses filled with water automatically detect the electrical and magnetic data at the vertical component of the ground at the place where the nail is driven and generate on themselves an equivalent radiation, electrical and magnetic field. This field does not only affect the cable but also a certain distance on the right and left of the cable. Cables perform the same function when they target a farther object (like an airplane, star, planet) with the conductors on their ends.

10. Direction Trays

It is a tray which can rotate 360 degrees about its axis to facilitate designation of direction, is made of a nonconductive material, and on which a measuring nail is connected in a horizontal position.

Measuring Circuit

Parts of the device are prepared fro the measurement by being connected to each other as shown in FIG. 12. In the connections, connecting means such as bolts, connectors, grips, sockets, soldering are used. The ready-to-be-measured position of the device is schematically shown in FIG. 9, together with the scanning position (15) and the measuring position (16). With these, it is aimed to facilitate the drawings regarding the measurements.

Measuring Station

The device described above can be used in all kinds of land conditions since it is portable. However in measurements for earthquakes and space investigations specific locations are selected in order to ensure persistence of the measurements and stations are built at these locations. With this purpose, certain auxiliary hardware is incorporated to the device (FIG. 14). First of all, the rods are mounted very precisely (4). Then a sensor is arranged on the exterior of both of the rods (29). The function of the sensors here is to ensure that the rods are persistently parallel to each other. If the energy of the location which is being measured increases, the rods approach each other, in this case the programmable electronic brain (25), which evaluates the signals sent by the sensors, gives a command to the automatic current controller (24) to increase the current, and the current provided to the coils increase until the rods come parallel to each other. If the energy of the location which is being measured decreases, the current applied on the rods moves the rods away from each other. This time, the electronic brain gives a command for decreasing the current, and the current is decreased until the rods are parallel to each other again. In the meanwhile, the current value read from the ammeter is continuously transferred to a computer (27) connected to the system via an appropriate electronic circuit. With an appropriate program, the computer continuously converts these data into graphics. The graphics obtained are printed via a printer channel connected to the computer. In the meantime, the coils heat up since they persistently draw current. Water is sprayed on them in certain periods to cool the coils. (28). Here, air conditioning is not realized by blowing air via devices like ventilators, fans, because an electrification occurs due to the air current and this causes erroneous results in the measurements of the device.

Areas of Use of the Device and the System

1—Geological Faults Detection Method

In the state of the art, geological faults are detected by monitoring especially the traces left by rupturing of the faults on the land surface in mountainous terrain. If there is no trace in the land left by the fault or if the traces are in the seabed, geophysics methods like seismic methods, gravitation method and resistivity method are applied.

The inventive method is completely different from these. It is easy to apply, the investment required is small and it is an inexpensive and reliable method. With this method, faults can be detected easily from the main fault to the secondary fault in detail. Faults can also be detected by mounting the measuring device on mediums like satellite, airplane, helicopter and balloon. There is no other method in the world which is as easy, reliable and economical as this method.

As is known, faults are of great importance for settlement plans of cities, ground waters, mining, oil searches and earthquakes. Since the faults in the settlement areas of the cities can be detected in a very inexpensive and economical manner, if settlement plans of the cities are made and the foundations of the buildings are laid in accordance with the obtained information about the location of the faults, damages in a possible earthquake will be minimized.

In this method, the measuring rods are held up in air parallel to each other and horizontal to the ground, either in between the fingers or palms of the user (17), or as mounted in their bearings (9). If the rods are not held properly and in balance, due to the change that will occur in their center of gravity they may move right/left without an external factor. Here, the measurement is performed by two rods, one in each hand. Especially the flat rods are also used in quadruples. In this case, the rods should be used by two people. If the user is holding the rods between her/his fingers, fingers of the user serve as bearings. In this case, the rods should be held by the user with a normal firmness and in such a way that the movement of the rods is not impeded. The coils wound around the rods are given a current which will slightly electrify the rods. As this current can be given so as to charge the rods with opposite charges, it can also be given so as to charge with the same charge. When charged with opposite charges, the rods draw each other, even if to a small extent, as a result of this charging. When charged with the same charge, as the rods will repel each other, there might be difficulty in detecting very small fault ruptures. Here, preferences are made according to the circumstances. The potential difference between the right and left hand finger tips is measured by a voltmeter. If there is a potential difference of about 100 millivolts between the finger tips of the user, the electric energy in the user's body is sufficient for scanning. In this case it does not matter if current is supplied or not, or in cases where energy of the faults is high there may not be any need for a current. The user walks in the land this way. When stepped over a fault, if the rods move spontaneously and intersect the fault perpendicularly, the rods become intercrossed (15) as shown in FIG. 15. The point where the rods are intercrossed gives the exact fault rupture line. If the user walks towards the fault, the rods open to right and left and make a swinging movement (33) as shown in FIG. 16. This way, the faults can be detected very easily.

If the fault is broken vertically, the first intercrossed point is the first rupturing line of the fault. If proceeded a little bit forward and returned from the opposite direction, the second fault rupturing line is found (15). The distance between these two rupture lines gives the width (31) of the fault. If the fault is Very big, e.g. if it has a width of 50 meters, the rods intercross at the right and left boundary points and at some points in between. These points where the rods intercross are generally veins which carry water within the faults. Not only the normal faults, but also dykes, thrust faults, layer changes, transpression zones and all kinds of geological formation boundaries are detected with this method.

Sometimes the fault does not comprise only a single rupture, it is fault zone. This zone may consist of tens of ruptures parallel to each other. In this case, the rods intercross separately on each rupture. Thus it is determined how many ruptures there are in that region. After detection of the main faults, the secondary faults are detected by walking parallel to the main faults. If there is a plurality of fault systems in the region, all ruptures of these systems and the points where the faults intersect are easily determined by this method. If two faults intersect, at the intersection point, the rods intercross at the direction of both faults.

After the ruptures are detected, the rods are held up in air, horizontal to the ground, above the intercrossed points. Then by supplying current to the coils of the rods so as to charge the rods with the same charges as shown in FIG. 17, it is ensured that the rods repel each other. By adjusting the strength of current with a current controller, the rods are ensured to be parallel to each other. Here, the current which repels the rods to enable them to be parallel to each other stabilizes the force which enables the fault to draw the rods. Thus, the amount of current depending on the energy born by the fault is measured. The point that needs to be drawn attention to is as follows: The distance (34) between the rods is fixed at a certain distance by tying a rope to the handles (1) of the rods or the distance between the bearings is adjusted to a certain size. Because all of the data are retrieved under the same conditions and then compared. For example, if the distance between the rods is adjusted as 10 cm and the current is measured to be 5 amperes, when the distance between the rods is increased to 20 cm the said value increases to 10 amperes and when it is decreased to 5 cm, the said value decreases to 2.5 amperes. Even if values of different sizes have been obtained, first of all the counterparts of these values in the selected distance are calculated and the comparison is made according to these results. The value of the current density of the fault measured at a certain length as amperes or milliamperes generally provides information regarding size and activeness of the fault, and the water flow it carries. Generally, the greater the energy of the fault, the larger and more active is the fault.

Measurements made by supplying current to the coils of the rods can also be made by connecting magnets to the rods so that they repel each other, instead of supplying a current. Here, the force of the balancing magnetic field is provided by adding or removing magnets to the rods. Again here, the force of the rods repelling each other stabilizes the drawing force that fault applies to the rods.

The processes carried out by the rods can also be performed by using four flat measuring rods. In this case, two people perform scanning in the land by each holding a rod in one palm. When the rods detect something, the ends of all four rods coincide at the same point.

The processes carried out by rods are also performed via the bow (7) shaped rod provided in FIG. 6. In this case, a single rod is used. Both ends of the bow are held in the palms, the sharp end of the bow is held facing forward and the person walks by holding the bow horizontal to the ground. As it is approached to the fault, the field created by the energy in the human body on the rod or the electrical and magnetic field created by the current supplied to the coils interacts with the electrical and magnetic field of the fault, and depending on the force of reeling or drawing generated in between, the end of the bow either ascends or descends. However here, the bow does not move exactly over the rupture like it does in the rods, it moves at a distance of about 0.5-1 m to the rupture, because the electrical and magnetic field of the fault constitutes a set in front of the fault, this field moves the bow before it comes above it. Based on the above, it is concluded that on top of the fault rupture there is a regular electrical and magnetic field extending from the rupture to the space. This field is almost an electrical and magnetic curtain. When the bow approaches this curtain the curtain immediately responses to it and keeps the bow away. In this system, rods are emphasized more as the process with the rods is easier. But all the processes and the measurements (detection and measurements of faults, water, earthquake, etc.) carried out with the rods can also be performed by the bow.

With this method, dips of the faults and the directions of the dips can easily be determined. The rods intercross at the beginning of the point where the fault is richest in terms of water and mineral, because in this section the electric charge and the current amount born by the fault increase. In relation to this the electrical and magnetic field intensity and consequently amount of radiation and the energy amount emitted increase. If there is a trace on the land surface of the fault and the rods intercross on this trace, this shows that the fault is a vertical fault. If the intercrossing occurs at a different point than the trace, this shows that the fault is dipped towards that direction. For example if the intercrossing occurs more to the north of the trace on the surface at a fault of east-west direction, it is understood that this fault is dipped towards north. If there is no trace of the fault on the surface, then the vertical (perpendicular) component of the fault is examined. A nail is driven to the point where the rods intercross. One end of the measuring cable is connected to the nail and laid on the land properly and such that it will be on the same altitude. The other end of the cable is isolated. In this case, the cable spontaneously carries all the data that can be measured at the underground vertical structure onto itself and ensures that these acquire a horizontal position. Thereby, the opportunity of watching the vertical component in horizontal position is provided. The nail driven to the ground and the cable ties thereto serve almost as an antenna for the under ground. The concerned person holds in her/his hands the measuring rods parallel to each other and horizontal to the ground, just like in scanning, and walks on the cable starting from the nail as shown in FIG. 18. When the rods over the cable reach in terms of depth the fault's active point (38), they spontaneously intercross (15) and this point is marked. Then the distance between the nail and this point is measured via a meter and the depth at which the fault's activeness begins is found. Afterwards, by driving a nail a little forwards and a little backwards of this point, again the active depth of the fault is found (39). If these depths are the same and there is no depth obtained in the second and third points, the fault is a vertical fault. If an active point is found at a place deeper (39) than the first point, this means that the fault is dipped to that direction. Dips of the faults are determined this way. Additionally, with this system, not only the dips of the faults but also the horizontal faults, layer change points at lands with layers, and the distances between the layers. If the person continues walking over the cable, whenever a horizontal fault is encountered or at each layer change, the rods intercross. This is because a different electrical and magnetic field forms at these points since there is an electrical potential difference (contact potential) between the layers when a horizontal fault is encountered or at layer changes. These values are reflected on the cable exactly the same. These points are marked, measured via the cable and their depths are found out. Then, current is supplied to the coils at the ends of the rods so as to charge the rods with the same charge (16) and they are maintained in parallel position. The magnetic field force or current density depending on the energies of these depths is measured over the cable. The current density of the depth of the point at which the measurement is carried out on the cable is measured in amperes. Additionally, the measured current provides information regarding the electrical, magnetic fields and energy of these points. The cable takes on all the electrical and magnetic properties of those points. The measurement via the cable is carried out as follows: The rods are held up in air over the cable parallel to each other and horizontal to the ground (FIG. 18), where the coils of the rods are supplied current making them repel each other (16). When the rods are parallel, the current repelling the rods stabilizes the force of the field forming over the cable. There is no problem of depth here. However many meters of cable is laid, that much depth is measured. The length of the cable starting from the point where the nail is driven, gives the depth of that point. The point where the nail is driven gives the uppermost point and the end of the cable gives the deepest point. For example, if 500 meter cable is laid, the last point gives the depth of the 500th meter. It is important here to lay the cable at the same line and same altitude. If there occurs curling on the cable, not the net length of the cable but the depth of the horizontal distance between the point where the nail is driven and the end point of the cable is measured. Likewise, the altitude of the land is also important. The cable should be laid at the same altitude as much as possible. Supposing that the 100th meter over the cable is being measured but the place where the nail is driven is 10 meters higher in altitude than the place where the measurement is carried out, in this case, the 100th meter depth is measured according to the altitude of the point which is measured. That is in fact, 110th meter depth of the point where the nail is driven is measured (44).

With this method ideas could be formed about the activation periods of the faults. In an active main fault zone, large ruptures parallel to each other are detected. In how many years the big earthquakes are repeated in this fault system can be determined from the historical records. Upon multiplying the repetition periods and the number of ruptures, approximate information can be obtained regarding the activation period of the fault. Supposing that 30 main parallel ruptures are detected in a fault system and the repetition period of big earthquakes in this fault is 250 years; it may be stated that the activation of the fault has continues for 250×30=7500 years.

Theory of these events can be explained as follows: For example, if a magnet is divided into two, it becomes two different magnets. Land pieces behave like different magnets at the lines of rupture and a different magnetic field forms at these locations. Furthermore, since there is a continuous movement and transgression along the friction surfaces of the faults, a continuous electrification occurs in these regions and here, an electrical field forms that is different from their surroundings. As it happened with the other objects, electrification also occurs at the fault surfaces due to friction. Furthermore, faults bear more moisture and water than their surroundings. This moisture and water store electrical charge like a condenser (FIG. 20) and at the same time, serves as a conductive for the electrical currents formed in the ground or in depths of the ground. The electrical current which is formed by friction of the faults, geochemical reactions and impact of magma, is carried and accumulated more intensely in the section of the faults where water is born. Thus here, a different electrical and magnetic field is formed. On the other hand, according to the black body radiation of Mac. Planck, substances radiate in proportion with the energy amount they bear. Accelerated charges produce radiation according to the law of Biort Savart. Due to the electrical charge accumulated by the fault condensers and the current produced here, the amount of waves emitted from here also increases. The said radiation produces an electromagnetic wave density and magnetic field here. When the measuring rods enter into the magnetic field of the faults, this magnetic field produces a magnetic torque like a galvanometer on the current passing through the coils of the rods. The rods intercross upon turning due to the impact of the distribution of the charges produced by this torque and the electrical field of the faults on the rods (FIG. 13) and the mutual inductance formed between two conductors within a magnetic field. Thus the faults are detected. At this point, the following different approach can be brought up: As it will be explained, in the mine detection section, each material has a specific current and there is a related radiation. When the rods enter the electrical and magnetic field of the faults, the natural electrical and magnetic rays of the rods interact with the electrical and magnetic rays of the fault. As the flow of the faults' rays is more, by charging the rays of the rods with opposite charges, the rods are ensured to attract each other.

In this system, what the device measures is not only the magnetic and electrical field. Although it measures all of these properties it measures a very different property. Because, if only one electrical and magnetic field is measured here, the values to be obtained should decrease as it is moved away from this field. Whereas in this system, the values obtained when the rods are held up at a height of 10 cm are found to be the same with the value measured at a height of 1 m and even the value measured at a height of 10 m. For that reason these values can also be measured by mounting a device on mediums like satellite, airplane, balloon and helicopter. If a normal electrical and magnetic field was measured, these values would have to decrease as moved away from the ground. Whereas the value measured here is not dependent on the distance (height). Since this value is not dependent on height, either there has to be a regular electrical and magnetic field here which extends from the ground to the space, or it should exhibit the feature of electromagnetic wave. Because according to the electromagnetic wave theories of Mc. Planck and Louis De Broglie, energy of the photon doe not decrease with the distance it travels. For example, the photons thrown from the sun or stars maintain their energy until they arrive at the earth unless they are absorbed by another substance or engage in an exchange of energy with other substances. However, a normal electromagnetic wave is not affected by the electrical and magnetic field if it is not comprised of charged particles like electrons, cosmic rays. In this system, since the measured waves are affected by the electrical and magnetic field and in fact they themselves produce an electrical and magnetic field, they should be comprised of charged particles or there should be a different kind of wave surrounding them which produce an electrical and magnetic field. At this point, the following idea can be brought up; the photons falling on the surface of a metal produce electricity current by ripping off electrons from the metal (Photoelectric event and Compton event), therefore an electrification may occur. In this case, since both of the rods will be charged with the same charge, they should not attract but repel each other. In fact this event is tested by the following experiment. When the rods are kept parallel to each other and horizontal to the ground for a period of time under a lit electric bulb like making a measurement, it is observed that they repel each other. The reason of this is that the photons coming from the bulb rip off electrons from both of the rods and charge both with the same charge and cause the rods repel each other. However the waves measured by the present invention charge the rods with opposite charges and ensure that they attract each other. Therefore, the waves measured by this system are charged and they produce a regular electrical and magnetic field. In other words, these radiations are not only normal electromagnetic waves but they are comprised of charged particles or they are a different kind of wave which exhibits an electrical and magnetic property. These waves will be explained in more detail in the section of the feature measured by the device. These waves are polarized and they are spread out along a line.

Like in the experiment conducted under the bulb, in cases where the rods repel each other, the value of the electrical and magnetic field which is produced upon supplying current to the coils of the rods so that they attract each other, is measured in currents.

2. Ground Water Detection Method

The methods known to be used in detecting ground waters are the geophysics methods such as the resistivity method, seismic methods, NMR (Nuclear magnetic resonance) method. In resistivity method, the resistance of the ground at various depths is measured upon supplying electric current to the ground by cables from specific distances. Structures of the soil or rocks are predicted according to these resistance data. According to the permeability of the soil or rocks, predictions are made about whether or not they will yield water. Most of the times, these predictions are insufficient. In the seismic method, seismic waves are sent to the ground from specific points. Predictions are made about liquid levels according to the reflection of these waves from different units. In NMR method, magnetic waves are sent to the ground via a ring. The waves coming from the liquid are detected by a coil within the water and transferred to the device. Liquid level is estimated by these data. There is a depth problem in NMR method. The device becomes insensitive after a certain depth. If there are magnetic minerals in the land, they mislead the device.

The inventive method is completely different from these. This invention detects natural signal, current and waves coming from the water and gives a result depending on the quantity of these natural data. Even though cable is used also in this invention, their functions of use are different. In resistivity method electricity current is supplied to the ground by cables from various points. Cables are used for this purpose. In the method of this invention, cables detect the natural signals, waves, currents in the vertical composition of the ground at the point where the nail is driven and exactly reflect the characteristics of each depth to different points on itself. In this process, there is no need to supply any current to the cable. The cable automatically fulfills this function with the current it receives from the ground and the air. In fact in this method, the end of the cable which is exposed is isolated. Otherwise, when the other end also contacts the ground, the current completes the circuit and it gets difficult to obtain reliable values. In this system, even if the nail is not driven on the ground, if it is held vertically such that its sharp end faces the ground and its peak point is isolated so that its peak point does not receive current, then it will again capture all data at the depths of the ground and convey them onto the cable. There is no similar invention anywhere in the world. There is no problem of depth in this system. It may as well be thousands of meters deep. In this method, as cables made of all kinds of metals and alloys can be used, fiber optic cables can also be used. Even wires and wet ropes can be used, however in this case, since electricity will be received also from the other parts of the soil, it may cause errors. Or water can be filled into a thin hose. From one end of this hose, a conductive wire is immersed in the water and it is closed by a stopper to prevent water from flowing away, and the other end of the wire is connected with a nail. Then the other end of the hose is closed as well and used for the same purpose. By means of this method, liquid level is determined directly. With this method, it is determined at which meter it is entered into the water, until which meter there is water and the water flow rate to be obtained from the well to be drilled. Besides, if there are several aquifer layers on top of each other, the start and end points of these layers and the flow rate of the water each aquifer layer carries can be determined. This method is easy to use and it is highly economical and reliable.

As is known, faults provide natural channels for ground waters. As it is done in the fault detection, one walks with the rods to detect the ruptures in the land where water will be searched. When surface scan is being carried out, there is no need to carry all the weights of the device. It is sufficient to carry only the connection cables together with the rods and a small battery which will provide energy to the rods. Sometimes, a battery will not be necessary either. The other equipments are activated during measuring of the energy (current). The rods are held up in air above the designated point, horizontal to the ground, such that they will correspond to the point that they will intercross. Then, electric current is supplied to the coils wound around the rods enabling the rods to repel each other (16), ensuring that they are parallel, and the current density which stabilizes the energy of the rupture is measured. Here, the distance between the rods should be kept fixed. The distance between the rods is not important when scanning at the surface, but it is important in measurement of the current. Of course among other things, lengths of the rods should also be standardized, however the same values can be obtained with rods of different lengths. Supposing that the distance between the rods is set as 10 cm, all the measurements should be done within this distance or the values of this distance should be calculated. Whichever distance is taken as basis, all the evaluations should be made in the selected distance, because the distance between the rods gives the current density of the place where the measurement is carried out. The measured current of the rupture provides information regarding the flow rate of the water it bears. The value read at the surface, provides information about the flow rate at the uppermost point of the water level. If few ruptures are detected at the land, the rupture which gives the highest current is the one which carries the most amount of water. Later, the nail (36) to which the measuring cable is connected is driven to the determined point and the cable (37) is laid onto the land properly and at the same altitude (FIG. 21). Then, the user holds the measuring rods up in air, parallel to each other and horizontal to the ground, and walks over the cable. When s/he approaches the depth (46) where there is water, the rods intercross and this point is marked. At this point, the rods are held up in air over the cable and current is supplied to their coils such that they will repel each other. If the current is too much, the rods open up, if it is too little they close down, and if rods are parallel, then it means that the force of the electrical and magnetic field of the current coming from the ground to the measuring cable has stabilized it. This value depends on the energy born by the water at the said depth and provides information about the flow rate of the water at this point. The value measured here is the same as the value measured at the surface. If proceeded from this point to the nail by 50-60 cm and the current is measured there over the cable, generally a lower value will be attained. This value is the value of the part of the fault which does not bear water or the value of the soil or rocks that are present there. The distance between the nail and the point where the rods intercross gives us the starting depth (46). Then the user continues walking over the cable and all the points where the rods intercross are marked (46, 47, 48 and 49). Then, by holding the rods up in the air, the current values of these points and certain sections between these points which will keep the device and the rods parallel (16), are measured. The values of this current provide information related to the flow rate of the water at the measured depth. In some places, the flow rate value at the top point is the same as the flow rate value of the bottom point, in some places the flow rate increases from the top to the bottom, in some other places the flow rate increases until a certain depth and then decreases again. After the point where the water layer ends, the current value decreases to the normal value of the soil and rocks. After the point where the current decreases, it is realized that it is entered into an impermeable and water-poor layer (54). Sometimes, until a certain depth, the impermeable layer continues and then it is again entered into permeable layers that bear water. Thus, how many meters should the well be drilled is planned in advance. Let us further explain this with an example: Supposing that the cable connected to the point where the nail is driven is laid for 200 meters, then the user walks over the cable starting from the nail, holding the rods in her/his hands; the rods intercross at the 10th meter, that point is marked, then intercross at the 25th meter and that point is marked, then intercrossed and marked at the 60th meter and then at the 90th meter, later the user walks until the 200th meter and no intercrossing occurs. At this point, the user returns and measures the current at 8th or 9th meters while holding the rods over the cable. Suppose that when the distance between the rods is adjusted to be 10 cm, 1 A/dm current density is measured. This is the density of the layer which does not bear current. Then at the 10th meter the current is measured as 3 A/dm, this current shows that at this point it is entered into the water and determines the water flow rate. Later, the current of the 15th meter is measured to be 3 A/dm and the current of the 25th meter is measured to be 4 A/dm. This situation shows that the flow rate of the water increases at the 25th meter. The distance between the 10th meter and the 25th meter gives us the thickness of the first water layer (aquifer)—For example (51)—. Intercrossing of the rods at the 25th meter, shows that either there is a horizontal fault here or a fault coming from another direction at this depth intersects here or it is entered to a different water layer, in other words, that there is a layer change. Since there is a different contact potential between the layers, electrical and magnetic fields of these places are different. This difference is exactly reflected to the cable and the rods immediately catch this difference. This way, current values of all the layers are measured. Supposing that at the 89th meter, the current is measured to be 6 A/dm and at 91st meter it is measured to be 1 A/dm. The following is understood from these data: at the 90th meter, a water rich layer has been found. At this point, it is sufficient to drill a well of 92-93 meters so as to form a base. Then, if there are wells drilled at the region which is searched, they are also measured the same way and the measured current values are recorded and the water flow rates of those wells are searched. The current values and the water flow rate of the driller wells are compared with the current values of the point to be searched, and how much water flow rate will be attained from the well to be drilled will be determined by 90% accuracy. If there are no drilled wells in the region, usually, how many liters/seconds of flow rate correspond to one A/dm current is determined. Predictions are made according to these data. The point that should be paid attention to during these processes is to ensure as much as possible that the cable is laid on the land properly and on the same altitude. For example, the 100th meter over the cable is being measured, but the point where the measurement is carried out is 5 meters higher then the point that the nail is driven. In this case, 95th meter depth of the point where the nail is driven is measured. Again, if for any reason the cable is tangled, for example when measurement is being carried out at the 120th meter of the cable but the real horizontal distance between the place where the nail is driven and the point where the measurement is being made is 100 meters, then in reality, the 100th meter depth is measured.

If no vein or fault is encountered in the surface scan of the land, nails are driven at several places of the land, measuring cable is connected to these nails and the user walks over the cable the same way with the rods and if there occurs an intercrossing, it is understood that there is a horizontal layer of water at the depth where there is intercrossing. Continuing to walk over the cable; thicknesses, depths and current values of the existing water layers are recorded. The same procedures are repeated at several points and it is determined whether or not there is water in the land. If there is water, it is decided to drill a well at point where the current value is the maximum.

If at a location, there is a water body which is not mobile or in the form of a vein but in the form of a pond (like in FIG. 22), the rods intercross at the boundaries (56) of this body and in between these boundaries at various directions. Then nails are driven at several points between these boundaries and measuring cable is connected, and the depth of the water (57), thickness of the layers (58 and 59) and the current values are measured whereby the flow rate of the water to be obtained is determined.

With the method of this invention, fresh waters and mineral waters and the difference therebetween are also determined. If there is both fresh water and mineral water in the same land, by following their faults and depths, it can easily be determined from which vein the fresh water flows and from which vein the mineral water flows. For example the fresh water veins and layers in that region are measured. Suppose that in these measurements maximum 150 m depth is measured. In the meantime, if there is a water vein which reaches a depth of more than 150 meters, the probability that this vein bears mineral water is over 50%. Depth on this vein is monitored a little further and if it is reached to depths of 300-400 meters it is realized that it is definitely mineral water. In some cases it is found that from several of faults that are parallel to each other mineral water flows while from the others fresh water flows. Even though these waters flow close to each other with a 10-15 meter distance in between and they are connected with other faults which intersect these faults perpendicularly, it is determined that these waters do not mix up. In some cases, a fault bearing fresh water passes over a fault bearing mineral water and their waters do not mix up. Depth, current value and the flow rate of the fault bearing fresh water is measured before the intersection point. A nail is driven and a cable is laid at the intersection point whereby depths are measured. With this method it is easily determined up to which meter there is fresh water, at which meter mineral water starts and the contact zones of these two water layers. At this point, it is determined that each fault bears its own water without getting mixed up with the other one. However here, the current value is the sum of the current values of both of the faults. The contact depths and current values are easily determined not only in the faults bearing fresh water and mineral water, but also in faults bearing the same type of water. For example, supposing that three fresh water faults coming from different directions are detected to intersect. Suppose that the waters born in the faults have a current density of 3 A/dm, 2 A/dm, 5 A/dm. At the point where these three intersect the current density is measured to be about 10 A/dm. If a nail is driven at this point and a cable is laid, each rupture's upper and lower limit points that bear water and the total current densities of these points can also be determined and measured very easily. That is to say, the fact that the waters of seas do not mix up in oceans as discovered by Captain Cousteau, the same is observed on the land, with the fresh water and mineral water and even with two fresh water veins.

With this method, underground rives can also be detected very easily. As shown in FIG. 23, the rods intercross at the right (60) and left (60) boundaries of the under ground river. Furthermore, at the mid sections of the river, the rods intercross in every direction. By driving a nail, laying a cable, walking over the cable and the rods intercrossing, how many meters deep the river flows (63) and the depth of the river (64) are measured. The rods are held over the cable that is laid to measure the depth of the river, and the flow rate of the river is measured approximately (16). Flow direction of the river is also determined. For this purpose, in the direction of the river, a nail (61) connected to a measuring cable is placed horizontal to the ground, on a non-conductive tray (62), towards the direction of the river, and its current value is measured over the cable (16); then it is directed to the opposite direction and its current value is measured (16). The direction where the current value is measured to be high depicts the incoming direction of water. A second way; the user holds the rods and walks towards both directions in the direction of the river in the middle of the river. The rods are pushed right/left more severely in the incoming direction of the river (66). The resistance of the water flow is almost felt.

Some events influence the current values read at the measurements, and the leading events are earthquakes. If an earthquake activity has started, current values of the under ground waters increase and after a while, current values of the main fault, secondary fault, small amount of water bearing fault, large amount of water bearing fault and all water either with or without mineral become equal to each other. In fact, even the hidden faults which do not reveal themselves reveal themselves and reach a high energy value. In this case, a reliable water prediction can not be made. In such a case, it should either be waited for this activity to finish or as it will be explained in the earthquake prediction section, the earthquake waves should be lost. If the earthquake is taking place close by, then the earthquake waves can not be lost for a long time. In such a case, the current remains fixed at several values at the same point (the rods remain parallel to each other). Predictions are made upon interpreting these values but this is not very reliable. Additionally, following very big earthquakes (e.g. with a magnitude of 9) taking place anywhere in the world, an overall increase occurs in the energy of the faults, ground and water everywhere in the world. In some cases, some very finely scattered minerals within the soil exhibit a value similar to water, this situation can be eliminated by examining the geographic and geological structure of the land. Or at these points, values are high starting at the uppermost point and when entered into water they decrease. Flow rate of the water is also lower. Since there will not be water at the upper points, it is realized that highness of the values originate from a mineral. Another misleading point is that, in lands with clay and marn, although water storage capacity of clay and aim is very high, since the flow velocity of the water is very low, even though a very high water flow rate is measured, sufficient amount of water may not be obtained from the well to be drilled, because the water can not attain the adequate flow velocity and can not flow into the well on time. If the depth of the water is not very much, caisson wells which are digged by digging tools are preferred instead of drilling. This is because in these types of lands sometimes water of a vein which is 10 cm away does not flow into the well. If a wide well is digged, the opportunity of cutting more veins increases, and as the surface of the well enlarges, more water is enabled to leak into the well.

A further misleading point is that if there is another transpression zone in the land and if transpression continues here, since crushing in the middle of this zone due to the influence of transpression goes on, the resultant energy may give a current similar to a high flow rate. Additionally, the marn in the lands with marn keeps in itself waves of previous earthquakes due to its elasticity. These waves can also yield to misleading results like water. All these drawbacks can be eliminated by examining the geological structure of the land. Or a result may be attained by measuring the features of the emitted rays such as their frequencies and wavelengths, amplitude, etc. These kinds of problems, as explained in the section named the feature measured by the device, are resolved upon determining the shapes and features of the waves. Over the cable connected to the determined point, shapes of the waves at the vertical and horizontal conjunction of that point are drawn. It is determined which waves are the water waves. By measuring the currents of water waves over their lines, more accurate predictions are made about water.

The following experiment is made: a washtub is filled with water and the current is measured by holding the rods of the device over the water. Water with a temperature of 23° C. is stabilized with a current of approximately 1 A/dm. When this water is discharged and the washtub is filled with hot water with a temperature of 56° C., then it is stabilized with a current of approximately 4 A/dm. These data show that, as the energy amount of substances increases, the amount of waves they emit increases, accordingly the current amount balancing the magnetic field also increases. By making use of this experiment, underground hot water sources are also detected. By making measurements at known water sources at a certain place, the required data are obtained. Then, data regarding the land which is suspected to include hot water is obtained and a comparison is made. Hot water prediction is made according to the result of this comparison.

With this method, flow rates of waters flowing through pipes and channels. For this purpose, firstly, the measuring rods held over the water flows whose flow rates are known and their current values are measured in A/dm. Then the current values of the pipes and conduits whose flow rates are unknown are measured, and the flow rates of unknown lines are found out by making comparisons.

3. Earthquake Detection Method

After the faults are detected by fault detection method, pilot faults are selected among them for continuous measurements. It is appropriate to select a secondary fault close to the main fault as a pilot fault. Because, if before the earthquake there is a main faults bearing a current of 10 A/dm and a close by secondary fault bearing a current of 1 A/dm, when the earthquake activity begins, the change in the main fault can not be recognized until the energy (magnetic field force or current density) of the secondary fault rises up to 10 A/dm. Furthermore, when the earthquake activity begins, energy of all the faults in that region becomes equal. Even hidden faults come to light. In this case, since the rate of increase will be more in the secondary fault, monitoring thereof will be easier. If possible, secondary faults which are connected to deep faults bearing mineral water are chosen. Because energy increases first start at the deep faults bearing mineral water, then dissipate from there to the secondary faults and other faults. In this method, monitoring earthquakes is divided into two headings as single earthquakes and sequential earthquakes.

Monitoring Single Earthquakes: Continuous measurements are conducted on the selected fault periodically, just like it is done in fault detection and water detection methods. If an earthquake activity has started somewhere, then the energy (current density) of the faults start to increase, values of increase and the periods are recorded. The word “energy” is used in the descriptions, because the changes in the current values measured are the results of the energy changes in the faults. As much as the electrical charge density is accumulated in the unit length of the fault or as much current passes from there, current is supplied during the measurements in between the rods in reverse direction that will stabilize that charge density or the current passing therethrough. For that reason, in place of these concepts, sometimes the term energy and sometimes the term current is used. Moreover, in order to make this situation more understandable the following experiment is conducted. When the measuring rods are held over a fire it is observed that the rods intercross. By supplying current to the coils of the rods, the current value of the fire is measured (as in FIG. 17), for example in a small wood fire, a current of 190 A/dm is measured. That is to say, due to the energy coming out of a fire, a current forms around the fire. The current formed and energy of the system measured are related. For that reason, some concepts are used interchangeably since they are related to each other. In fact, the value measured in the device is the current intensity. After energy reaches a certain value, it stays fixed for a period of time around the said value, although there are some fluctuations. The period between the time when energy starts to increase and the first time it starts to remain fixed, gives an idea about the distance of the earthquake to the point where measurement is conducted. The less this period is, the closer the earthquake occurs to the place where the measurement is being conducted. After the energy stays approximately fixed for a certain period it rises again, then again for a certain period of time it stays approximately fixed although there occur some fluctuations. Rupturing takes place at this position where the energy is high. After the rupture, energy stays approximately fixed at the same position for a period of time or in some earthquakes, it rises some more due to the energy released by the earthquake and remains more or less fixed. Then it starts to decrease and reaches its normal value. Thus the earthquake activity is completed. The same kind of changes is seen not only in earthquakes but also in volcano activities. With the same method, volcanic activities are also determined in advance.

The direction at which the earthquakes take place is determined as follows. When the earthquake activity starts, a nail connected to the end of the measuring cable or a metal rod (61) is held up in various directions, horizontal to the ground, over a non-conductive tray (62) at the place where the measuring is conducted. The said nail catches the earthquake waves emitted in the air in that direction like an antenna and transfers them to the cable. These waves produce an electrical and magnetic radiation and a corresponding electrical and magnetic field at and around the cable. By holding the rods over the cable, the current value balancing the force of this field is measured (16). During the measurements, the rods are enabled to repel each other by supplying current again to the coils of the rods so as to charge the rods with the same charge. At the position where the rods are parallel, the value of the force produced by the field over the cable is stabilized by the value of the current repelling the rods. This way, values of currents in different directions are measured. From whichever direction the current comes the highest, the earthquake is taking place at that direction or at subdirections near that direction. The current at the direction which gives a high value in the measurement reaches after a period of time the point where the measurement is carried out. This period also provides information about the distance of the earthquake. The current disperses from here to the other directions. After a while it is equalized at all directions. For that reason, direction finding is performed in a reliable way at the moment when the activation starts. Sometimes, contrary to the direction from which the highest current comes, the earthquake takes place at a different direction. The reason thereof can be explained as follows: Suppose that the earthquake takes place on a fault extending in the north east-south west direction. If this fault passes to the south of the point where measurement is conducted, controls are made when the activity starts. Suppose that the waves are predominantly coming from the south and east and the waves coming from the south are stronger; but the earthquake takes place in north east. This situation is caused by the fact that since the extension of the fault at which the earthquake takes place is nearer to the south of the point where the measurement is performed, the device early detects the waves thereat. In order to better understand these cases, the following tables are examined.

The data in these tables are obtained via a measuring device on certain faults in the city center and 10-25 km to the city center, in the province of Elazig, Turkey. In the experiments, length of the rods is adjusted to be 90 cm and the distance between the rods is set as 10 cm (1 dm).

TABLE 1
Date Time Measured current Currents measured at directions
(A/dm) (Hr and Min) (Ampere/dm) East West North South

18.10.2006 06:45 1
29.10.2006 08:00 1.14
29.10.2006 22:00 1
29.10.2006 22:01 4
29.10.2006 22:02 4.6
29.10.2006 22:08 4.7
29.10.2006 22:10 — 4.8 7.5
29.10.2006 22:16 — 8 12.5
29.10.2006 22:20 8 — —
29.10.2006 22:22 8 8 12.5
29.10.2006 22:42 12.5
29.10.2006 22:45 12.5 12.5
29.10.2006 22:48 12.5 — —
30.10.2006 05:30 16 — 16
30.10.2006 06:35 16
30.10.2006 08:30 15
30.10.2006 12:35 12
30.10.2006 11:27 * A 3.9 magnitude earthquake took
place at Caglayan county in the city of Erzincan, Turkey.
30.10.2006 13:40 12
30.10.2006 18:05 4.5
30.10.2006 18:54 3
30.10.2006 19:47 3
30.10.2006 19:34 * A 3.8 magnitude earthquake took place
at Dodecanese islands.
30.10.2006 20:15 3
30.12.2006 23:05 1

TABLE 2
Date Time Measured current Currents measured at directions
(A/dm) (Hr and Min) (Ampere/dm) East West North South

31.10.2006 13:25 1
31.10.2006 15:02 1.46 4.75
31.10.2006 15:08 5.5 11 5.5
31.10.2006 15:12 — — — 6.5 13
31.10.2006 15:15 12 12 6.5 13.5
31.10.2006 15:41 15 19
31.10.2006 15:45 19
31.10.2006 16:08 25 25
31.10.2006 17:35 25 25
31.10.2006 18:16 31 31
31.10.2006 20:26 15
01.11.2006 10:06 16.5 25
01.11.2006 12:02 25 25
01.11.2006 18:00 30 — 16 16 30
01.11.2006 21:43 30 30 16 30 30
01.11.2006 23:11 30 30 30 30 30
01.11.2006 00:00 32 32
01.11.2006 23:19 A 4.8 magnitude earthquake took
place at Yedisu county in the city of Bingöl, Turkey.
02.11.2006 08:43 30 30
02.11.2006 10:40 50 50
02.11.2006 17:23 50 50
02.11.2006 23:29 64 64
03.11.2006 01:50 40 40
03.11.2006 03:10 22
03.11.2006 09:45 2.36 2.36
03.11.2006 03:15 7 22 22 7
03.11.2006 20:45 1 1 1 1 1

TABLE 3
Date Time Measured current Currents measured at directions
(A/dm) (Hr and Min) (Ampere/dm) East West North South

05.11.2006 10:20 1
05.11.2006 10:22 3.74
05.11.2006 10:31 4 7.7 3.74 7 3
05.11.2006 11:04 7.5 8.7 8.7
05.11.2006 12:26 12 17 17
05.11.2006 16:33 18 40 40
05.11.2006 17:25 35 40
05.11.2006 22:48 60 60 60
05.11.2006 23:41 66 66
06.11.2006 06:17 66 66
06.11.2006 09:01 60 60
06.11.2006 12:03 80 80
06.11.2006 12:12 100 100
06.11.2006 18:44 100 100
06.11.2006 21:54 150 150
06.11.2006 23:58 150 150
07.11.2006 00:15 * Current values are reduced to 1 A by sending a
counter wave.
07.11.2006 00:21 150 150
07.11.2006 00:58 * Current values are reduced to 1 A by sending a
counter wave.
07.11.2006 17:30 50 50
07.11.2006 17:36 * Current values are reduced to 1 A by sending a
counter wave.
07.11.2006 21:43 150
07.11.2006 21:50 * Current values are reduced to 0.72 A by sending a
counter wave.
08.11.2006 21:10 0.58 — 0.58 0.58 0.58
09.11.2006 19:00 0.8
10.11.2006 10:05 0.8
11.11.2006 23:00 0.78
12.11.2006 12:20 5
12.11.2006 20:05 50
12.11.2006 20:20 * Current values are reduced to 1A by sending a
counter wave.
14.11.2006 13:30 3 * Current is reduced to 1A by sending a
counter wave.
15.11.2006 16:20 68
15.11.2006 * An 8.1 magnitude earthquake took place in Kuril islands
at the North of Japan.
16.11.2006 07:52 110
16.11.2006 12:00 145
17.11.2006 08:13 100
18.11.2006 07:00 67
19.11.2006 09:30 0.5

When the tables are reviewed, it is observed that in Table 1 a period of 48 minutes passed from the moment when the activity started until the value (12.5 A) that it first remained fixed and the earthquake took place in the city of Erzincan, Turkey. There is a horizontal distance of about 100 km to the place where measurement is carried out. In Table 2, a period of 66 minutes passed from the moment when the activity started until 25 A which is the value that it first remained fixed and the earthquake took place in Yedisu county, city of Bingol, Turkey. There is a horizontal distance of about 150 km to the place where measurement is carried out. In Table 3, a period of about 13 hours passed until 66 A where the energy first remained fixed and the earthquake took place in Japan. There is a distance of about 6-7 thousand kilometers in between. Accordingly the first increasing period of the energy (67) provides information regarding the distance of the place where the earthquake starts and the point where the measurement is carried out. The rate of increase in the energy (A1) before the earthquake also provides information about the magnitude of the earthquake. Here, the rate of increase should be considered as amperes rather than the current value. Because sometimes there occurs a decrease in the overall energy of faults worldwide and sometimes there occurs an increase (Especially after very big earthquakes). For example, a current value measured at a fault as 1 A/dm under normal conditions, may be measured as 15-20 milli amperes/dm in situations where energy decreases worldwide. Then the rate of increase relative to these values is taken into account. Furthermore, as the magnitude of the earthquake increases, the period the activity starts in advance (68) also increases. In order to be able to exactly locate the place of the earthquake, stations are established at different locations. It is determined from which directions the first activity comes relative to the stations. It is detected between which stations the earthquake started. Then, by narrowing area place of the earthquake is determined.

Sequential earthquakes: In the beginning, the activity course of the earthquake continues like it does in single earthquakes. However, after the first earthquake takes place, some fluctuations occur but the energy does not decrease; this earthquake triggers the subsequent earthquake. This situation continues by having the second earthquake trigger the third and the third trigger the fourth. Energy rises before and after each earthquake. Sometimes one day after an earthquake it decreases a little and then rises again. Usually it starts with small earthquakes and then the magnitudes of the earthquakes increase. After a big rupture, magnitudes decrease. After remaining at a maximum value for a certain period of time, the energy decreases. Sequential earthquakes do not necessarily take place close to each other. Sometimes they take place at the same geographical region and sometimes they occur at distances of hundreds and even thousands of kilometers. The situation will be more apparent upon review of the following table.

The data in this table are obtained by means of the system of the present invention on certain faults in the city center and 15 km to the city center, in the city of Elazig, Turkey.

The directions in the table show the energy values at the mentioned hour and directions. The earthquakes and important events that took place within this time period are given with an asterisk * mark together with the dates and, if available, hours.

TABLE 4
Date Hr & Current Hr & Current Hr & Current
Hr & Current Hr & Current min (A/dm) min
(A/dm) min (A/dm) min (A/dm) min (A/dm)

19.01.2007 1
20.01.2007 15:28 2.5 15:29 3.25 15:35 3.5 15:36East:5.52 15:36West:2.6
20.01.2007 15:36North:5.52 15:36South:2.40 15:44 4.40
20.01.2007 15:44East:18 15:44North:17.52 16:19 19 16:23East:71
20.01.2007 16:30 27 16:53 62 16:53:East:76 16:59 78 17:54 75
20.01.2007 18:42 78 20:05 78 20:09 90 22:18 90 22:28 110
21.01.2007 09:25 110 13:08 120 14:28 130 16:13 130 20:38 130
* A 5.0 magnitude earthquake took place at Tutak town of the city of
Agri.
* A 7.2 magnitude earthquake took place near Sulavi island of Indonesia.
21.01.2007 20:43 125 22:18 130
22.01.2007 09:10 150 18:30 150 20:10 150
23.01.2007 00:09 150 08:38 150 13:14 150 23:25 150
24.01.2007 08:10 160 19:05 160
25.01.2007 09:30 160 10:00 * Reduced to 2.5 A by sending a counter
wave.
25.01.2007 14:17 160 23:45 162.5
26.01.2007 07:48 175
26.01.2007 10:20 * A 4.7 magnitude earthquake took place at Ba [symbol] yurt
county of Karakocan town of the city of Elazig, Turkey.
26.01.2007 11:20 200 12:54 200
27.01.2007 07:47 133 10:01 130 10:07 160 12:57 170 14:30 190
28.01.2007 07:55 180 09:31 180 13:26 180 15:27 187 16:35 187
30.01.2007 15:46 187 18:55 187
31.01.2007 14:33 187 14:55 190
01.02.2007 09:20 175 10:50 177 13:00 170 15:00 190 16:40 212
01.02.2007* A 5.9 magnitude earthquake took place near Java island of
Indonesia.
02.02.2007 08:13 187
04.02.2007 15:10 202 15:50 200 16:46 220 17:16 220
05.02.2007 * A 6.5 magnitude earthquake took place at Caribbean Islands.
05.02.2007 09:40 187 10:46 187 12:21 198 15:01 190 16:30 210
06.02.2007 09:40 206 13:33 187 13:48 210
09.02.2007 04:22 * A 5.3 magnitude earthquake took place at Gözeli
county of Sivrice town of the city of Elazig, Turkey.
09.02.2007 08:00 266 08:40 248 09:21 218 09:34 228 10:04 228
09.02.2007 13:00 220 13:30 228 14:16 222 16:09 237 16:32 257
09.02.2007 17:00 270 18:07 280 18:15 280 20:21 280
10.02.2007 11:0 246 12:42 227 13:37 200 14:07 200
11.02.2007 16:00 203 16:22 237 17:07 242 18:05 245
12.02.2007 08:34 242 08:41 250 09:20 250
14.02.2007 07:53 247 08:57 247 09:59 250 12:59 240
17.02.2007 07:56 228 09:14 243 14:40 228 17:50 218
18.02.2007 09:15 232 11:24 228
19.02.2007 22:15 233 23:20 252 23:33 262
20.02.2007 04:48 274 06:18 330 06:23 316 07:05 311 09:46 300
20.02.2007 10:59 316 13:06 316 16:50 285 16:56 316
20.02.2007 * A 6.6 magnitude earthquake took place in Indonesia.
21.02.2007 12:12 333
21.02.2007 13:05 * A 5.9 magnitude earthquake took place at Sivrice
town of the city of Elazig, Turkey.
21.02.2007 13:08 320 14:14 325 15:23 316 17:16 333 19:43 333
21.02.2007 20:29 366 21:05 380
22.02.2007 01:43 400 01:55 430 10:10 400 10:31 450 10:43 458
22.02.2007 11:35 480 12:38 480 15:39 483 17:12 491 19:22 496
22.02.2007 20:10 496 20:11 * Energy is reduced by sending counter
current.
22.02.2007 20:25 486 * The reduced energy rose 5 minutes later.
This shows that the earthquake is at a near place.
23.02.2007 08:10 483 08:15 443 08:55 480 17:20 480 20:29 527
23.02.2007 20:58 528 22:23 796 22:37 773 22:56 763
24.02.2007 07:20 760 09:20 738 16:35 763 16:54 South :720A
25.02.2007 06:35 817 09:10 785 10:44South:740,East:745,West:714
25.02.2007 16:42 812
26.02.2007 06:35 815 22:05 782
27.02.2007 07:45 857 08:10 857
28.02.2007 * A 4.8 magnitude earthquake took place at Sivrice town
of the city of Elazig, Turkey.
01.03.2007 01:05 * A 4.7 magnitude earthquake took place at Sivrice
town of the city of Elazig, Turkey.
01.03.2007 13:30 857 15:13East:857,West:857,South:857 15:40 857
02.03.2007 08:10 857 19:20 857
03.03.2007 19:53 925 21:00 925 21:03 887 21:34 900
04.03.2007 { 01:00 891 01:45 891 02:00 900 02:10 891 02:28 885}
* Data given in brackets are obtained during moon eclipse.
04.03.2007 09:26 935 11:30 925 18:46 928
05.03.2007 11:32 914 19:29 928
06.03.2007 07:01 934
06.03.2007 * A 6.3 magnitude quake and an hour later a 6.0 magnitude
quake took place near Sumatra island of Indonesia.
06.03.2007 20:17 910 20:46 971 21:13 905 21:25 910 21:32 928
07.03.2007 05:56 971 07:01 971 16:10 971
07.03.2007 * A 4.8 magnitude earthquake took place in the Luristan
state of Iran.
08.03.2007 11:00 962 22:00 989
08.03.2007 * A 4.8 magnitude earthquake took place at Sancak town
of the city of Bingöl, Turkey.
09.03.2007 06:52 1018 17:15 1058
10.03.2007 09:12 1004 17:22 1030
10.03.2007 * A 4.7 magnitude earthquake took place at Sancak town
of the city of Bingöl, Turkey.
11.03.2007 06:45 1039 20:20 958 20:52 984
12.03.2007 06:42 1000 19:15 984
13.03.2007 06:20 1040 16:50 1068
14.03.2007 09:23 1048 09:30 South:1400 17:14 1053
14.03.2007 17:45South:1428,18:50 East:1342 18:50 1414
15.03.2007 09:34 1395
16.03.2007 10:00 1428
17.03.2007 11:45 1457 18:11 1541
18.03.2007 10:30 1571 22:15 1571
19.03.2007 09:19 * Current reduced by sending counter wave. 09:21
waves returned.
19.03.2007 09:29 1571
20.03.2007 09:29 1600
21.03.2007 09:20 1600
22.03.2007 14:15 1428 23:25 * Reduced to 4 A by sending counter
current.
23.03.2007 12:45 2.40
24.03.2007 10:20 123:00 1 * Tests for reducing current are carried out
in the day time.
25.03.2007 02:30 1
25.03.2007 * A 6.9 magnitude earthquake took place in Japan.
25.03.2007 11:36 130 11:53 130
26.03.2007 20:45 115
27.03.2007 12:29 130

On Mar. 14, 2007, a nail is driven on a fault bearing mineral water, a measuring cable is connected to the nail and measurements were made. It was determined that the fault started from the 6th meter and bore water until 420th meter, current values were measured, the current values at the level where it bore water was measured to be high (about 1000 A/dm) and after the level where the water ended the current value is measured to 1-2 A/dm. This situation shows that in earthquakes, although there occurs an increase in the overall energy of the ground, the most increase takes place in the waters born by the faults and in the ground waters. This experiment supports the theory that the waters in the faults and the ground waters behave like a condenser and carry the current.

After sequential earthquakes, a certain amount of current is produced in the faults. This current tours around the world. It causes earthquakes in various places in the world. This current continues for a long period of time whether an earthquake occurs or not. This current plays an important role especially in spring in rejuvenation of the plants.

As the in-depth energy changes in the faults (electrical and magnetic field changes depending on energy) can be measured by the cable, energy changes in much deeper points can be detected and measured by using very long—for example 15-20 km or longer—measuring cables. Thus, it can be predicted at which kilometer depth the earthquake will take place. Moreover, by using very long cable networks long enough to be able to detect depths of magma, movements and energy changes of magma can also be measured with this system in terms of current density. Thus, much more reliable predictions can be made regarding earthquakes and volcanic activities. In fact, after laying a cable, the wave systems and current values of the underground continue on the earth horizontally even after the cable ends. For that reason, data related to the underground can be monitored even after the end of the cable. However in this case, difficulty can be experienced in finding the direction and interference may occur with the waves coming from other directions. For these reasons, misleading results may be obtained.

Let us have a look at hiding of earthquake waves by sending counter waves: It is determined that the waves sent over some substances (e.g. platinum, iridium, osmium, briefly heavy and light platinum group metals and alloys thereof, gold and alloys thereof, that is any noble metal, graphite, fabric such as silk and like) attenuate earthquake waves for a period of time. A material of one of these substances is placed next to the fault where the earthquake activity is being measured. Then the coils of the measuring rods are held over this material and a current, whose value is close to the value of the current of the fault, is supplied to the coils, like carrying out a measurement, in a direction which makes them repel each other. The rods oscillate by opening and closing over this material and then they open. This action eliminates earthquake waves for a period of time, and then waves reappear. Thus, waves emitted over these kinds of materials produce waves in a direction opposite to the earthquake waves, attenuating the earthquake waves for a period of time at the place of measurement. In these experiments, it becomes apparent that the magnitude measured by this device exhibits the feature of a wave. This event is noticed when carrying out the experiments given in Table 3. As the earthquake waves appeared counter waves were sent and thus current values were reduced and the influence of sending counter waves on the course of the earthquake was monitored. When the earthquake took place, it is realized that counter waves prevent the earthquakes from coming to the point where measurement is being made, and that after the earthquake waves are eliminated the period until they reappear provided information regarding the distance of the place of the earthquake from the point where the measurement is performed. If the earthquake occurs far away from the point where measurement is performed, when the waves are eliminated they reappear at a later time, if they occur close by, they appear in a shorter period of time. This can easily be seen when Table 3 and Table 4 are reviewed. However, in the operation of destroying the waves, energy of the water or, if available, of the mineral born by the fault can not be destroyed. For this reason, in searches for water, if there is an earthquake activity in the region, influence of the earthquake can be eliminated this way and measurements for water can be performed. However, if the earthquake is taking place nearby, since the said kind of elimination will last only a few minutes, a reliable detection of water can not be realized. Earthquakes are prevented or shifted to other places when these procedures which eliminate the earthquake waves are repeated for a long time.

Can't earthquake waves be brought back after they are hidden? This time, if the same procedures are performed over materials like any base metals (active or half noble metals) or alloys thereof or a fabric like satin, wool, etc., rubber and etc., earthquake waves reappear. Thus, these kinds of materials produce waves that strengthen earthquake waves. In fact, if fabrics like satin, wool or a very thin metal (e.g. active metals as a thin folio), rubber, etc. are used, earthquake waves can be brought back by oscillation, without supplying a current to the coils. It is found out that each material has specific features that reduce or increase earthquake waves and a specific current value which stabilizes the waves it emits. However, fabrics like satin and wool, and rubber and some materials do not have such a fixed current value. No matter how much current is supplied over these kinds of materials to the measuring rods for them to repel each other, that much current is stabilized. Artificial earthquake waves are produced by making use of these properties of the materials strengthening earthquake waves. For example at a time when there is not any earthquake activity, a material of one of the substances which strengthen earthquake waves can be placed near a fault. A current corresponding to the desired A/dm of wave is supplied to the rods, when they are oscillated over the material, even after the current is cut, a wave that corresponds to the adjusted current density is produced there. The current can be increased as much as possible over these materials. These kinds of artificial waves are brought back to their original state by resending a counter wave. These experiments show that artificial earthquakes can be produced by making use of the said features of substances. These operations are continuously repeated to produce artificial earthquakes.

Processes of attenuating and uncovering earthquake waves are also performed as follows: If the handle (1) part of the measuring rods is held with materials destroying earthquake waves and they are oscillated over the fault, e.g. handles of the rods are held up upon being wrapped with a silk fabric, earthquake waves return. If the same procedures are carried out with materials strengthening earthquake waves, it destroys the earthquake waves. In these processes, not supplying current to the rods does not affect the result. Another way to hide (attenuate) earthquake waves is to connect a magnet to each rod at the top of the handle (1) part. The rods are oscillated a little and are left and waited this way on the fault. The longer it is waited this way, the later the earthquake waves appear after the magnets are removed. This way, even if the earthquake is near, the earthquake waves can be attenuated for a longer period of time.

With this system, in some lands, waves of previous earthquakes can also be monitored. Formations like marn which have a resilient structure, retain earthquake waves therein. A fault line is detected at such a land. Then the depth is measured on the said line by means of a measuring nail and cable and the active top and bottom points of the fault are detected. Nails are driven to the right and left of this point with 5-10 cm intervals. When the active upper and lower depths of each point is measured with the cable, a structure similar to the graphics drawn vertically by seismographs appears. On this structure, currents of each peak and lowest point and the middle points are measured.

Two theoretical ideas can be put forward regarding the reason of the energy increase in the faults before earthquakes. The first reason: when the earthquake begins, the energy that is released as a result of the crushing that occurs at the place of the earthquake produces a current. The current that is produced here accumulates within the waters born by the faults like a condenser (FIG. 20). This current is transmitted to everywhere in the world by means of the waters in the faults. Thus, an earthquake that takes place in Japan is also monitored in Turkey. The energy exposed during the said crushing fills the faults. After a sufficient crushing occurs, rupture, in other word the main shock of the earthquake takes place. In the meantime, the amount of electrical charge accumulated in the faults and the current produced as a result of water and ions dissolved in water, produce a magnetic induction, heats the place where there is crushing and facilitates crushing. When the charge intensity in the faults reaches a sufficient value, if blows up the place where there is compression. For instance, we can test this event with the following experiment: If a current which is beyond the capacity of the condenser is sent to the ends of a condenser from the opposite direction the condenser explodes.

The second theory: If a compression at a place reaches a point of impeding movement of lands, self protection system of the world is automatically activated which accumulates the current that is produced by the world, in the faults and the ground waters. As it is explained above, this current produces a magnetic induction in the faults, and heats and softens the place of compression. Maybe, a thermonuclear reaction starts at the place of the compression due to the influence of this induction. The increases in the radon gas output before the earthquakes can be a result of this reaction. The amount of electrical charge in the faults and the current intensity produced accordingly or the resonance density produced by the resultant vibration produce the necessary magnetic induction and when it reaches a force to rupture the place of compression the rupture takes place. Furthermore, the amount of electrical charge accumulating in the faults and ground waters and the current flowing through the faults provide an electrolytic dissolution here and increases the dissolved mineral amount in the ground waters before earthquakes. Increase in the thermal solubility due to the temperature increases under ground with the influence of the magnetic induction that is formed, increases the amount of dissolved mineral in waters.

The following objection may be made here. Can the current density accumulated in the waters within the faults provide a force big enough to enable a rupture at the place of the earthquake? Upon reviewing the above given tables, it is observed that thee is a linear current density of 12 A/dm-1600 A/dm in the faults during earthquake activities. When the vertical component of the fault is examined by means of the cable, it is observed that in the layers bearing water, there is the same current density vertically as well. In this case, it is seen that a surface current density from 12×12=144 A²/dm² to 1600×1600=2560000 A²/dm² occurs per square decimeter. If hundreds and even thousands of parallel, vertical, horizontal ruptures and surfaces of water bearing layers depending on tens, hundreds, thousands of kilometers of length are calculated and multiplied by the current density at each dm2, it will be seen that the value of the magnetic induction to be produced will be very high. Moreover, the following experiment was conducted in order to prove the relation of the measured value with the current of the system: The AC current drawn by an electric motor is measured. It is determined that it draws a current of 22-23.8 A. Later, it is measured by the measurement device over the cable which carries current to the motor (like in FIG. 17). The value obtained here is 21-24 A/dm. In this case, the current intensity which stabilizes the electrical and magnetic field produced by the wave measured by the device in decimeter, is approximately equal to the current drawn by the electrical motor. This experiment shows that the A/dm current density measured in the faults is equivalent to the amount of current born by the fault.

4. Mine Detection Method

When measuring rods are held over various metals, mines, minerals, fabrics, plastics and etc., it is observed that the rods intercross over them. Some are affected very much while some are almost not affected at all. Then, if current is supplied to the coils of the rods sufficient to stabilize the value of the substance that is measured, the current density specific to each substance is measured. That is, each substance emits a specific wave and there is an electrical and magnetic field produced by this wave. For example, it will be seen that if measurements are conducted over a material like gold, platinum, then the current value will be 5.5-7.5 A/dm, while for materials like iron, copper, silver it is 1.5-2 A/dm, for graphite it is 8-13.5 A/dm, for chrome ore (chromite) 8-8.5 A/dm, for iron manganese ore 4-4.5 A/dm. It is determined that each substance has such a specific current value. These kinds of current values are not fixed but they change according to the overall energy change. For example, increases are seen in current values during earthquake activities. However these increases will not be as much as the changes in the waters. In the waters, values change according to the water flow rate. Whereas in the other substances, values do not change according to the amount. Mines and treasures are detected by making use of these features of the substances.

Like the fault and water detections, a scan is conducted by means of the measuring rods on a land possibly containing mines. The rods intercross when stepped over a mine deposit. If mineralization is in the form of a lens (head), the rods intercross at the boundaries of this lens (69). Furthermore, the rods intercross at every direction over the ore. Thus the size of the lens is determined. Then by holding the rods over the head and supplying current to the coils of the rods such that they repel each other, the current value (A/dm) which stabilizes the electrical and magnetic field produced by the mine is measured (16). Type of the mine is determined according to its current density. Current density may not alone be sufficient in determining the type of the mine. For that reason, as it is explained in the section “the feature measured by the device”, wave shapes of the mine is determined over the cable. Since each mineral has a specific wave shape, type of the mine can be predicted by making use of these shapes and by measuring the current of the wave over the wave line. Then nails are driven on several points on the head, a measuring cable is connected and depth (70) and thickness (71) of the ore is measured like it is done in water measurements. Additionally, current values are also measured over the cable. If a mine is searched for at a region where there is a certain mineralization, for example chrome mine is searched for at a land where there is chrome mineralization, firstly scanning and measurements are performed on the ore head (lens) detected in that region and the necessary current data and depth data are obtained. Then by comparing these data with the data obtained at the place of detection, more reliable predictions are made. At a place where a mine deposit is detected, the uppermost lens is detected from the surface. If there are other lenses under the upper heads (lenses), these are detected by means of the cable by measuring the depth values. If the mine is in the form of a vein, the rods intercross at the right and left boundaries of the vein and at the area between the boundaries of the vein. A nail is driven onto the vein, a measuring cable is connected, and just like in the water measurements, depth and thickness of the vein, and if there are several veins, start and end depths of each vein are determined. Thus the type of the mine is detected. At this point, the most misleading factor is the presence of ores or rocks which provide a similar current value. Since, sometimes water also provides different current values depending on its flow rate, it may also be a misleading factor in mine detections. However at this point, this factor is partially eliminated by examining the topographic and geological structure of the land. In another method, frequency and wavelengths of these waves are measured and as it is explained in the section “the feature measured by the device”, these kinds of problems are eliminated by determining the wave shapes. Since the values measured here do not depend on the depth, no matter how deep the mine is, data can be obtained.

5. Treasure Detection Method

In the mine detection method, it was stated that the metals are detected by the rods and stabilized with specific current values. For that reason, the said device is also used in treasure detection. Just like the water and mine scans, scans are carried out on the land which is suspected to include a treasure. The rods intercross when stepped over a treasure. The rods intercross at the boundaries of the treasure just like in the mine lenses. However here, the area is small and the rods intercross at every direction. Then a nail is driven and a cable is laid, and just like in the water and mine detections depth and thickness are measured over the cable. Afterwards, the current value is measured, compared with the metals and a prediction is made about whether or not there is treasure. However here, there are misleading factors. Historical ashes give a current value the same as the current value that gold gives. Some clay minerals, minerals and mines give a current value the same as gold does. These kinds of substances mislead all detectors for gold. But, as it is explained in the section “the feature measured by the device”, this problem is partially solved as the specific shapes and features of the waves of each substance are different. The objects which mislead the device the least are the metals except gold, because since the current values of the other metals are usually low, they are easily differentiated. There is no problem of depth in the detection of this device. No matter how much the depth is, the device performs detection and the depth is measured via the cable, because this device measured the natural radiation and energy emitted by substances. It is stated in the previous sections that these radiations are not affected by depths.

6. Oil Detection Method

In addition to being used in the detection of water and mine deposits, the device can also be used in detection of oil and natural gas reservoirs. For this purpose, first of all at a known oil or natural gas reservoir, geological structures like faults, dykes, trans-pression zones, salt domes, etc. are detected upon scanning from the surface by the measuring device, just like in the geological fault, earthquake, ground water and mine detections. Currents related to the land are measured and the necessary data are collected. Then measurements of depth are carried out over the measuring cable and the required layer changes and information related thereto are collected. Thus, all data regarding the land are obtained in three dimensions. The current values given by the oil layer are detected. As it is explained in the section “the feature measured by the device”, wave shapes of the oil layers and the features of the waves such as wavelength, period, frequency, etc. are determined. Contact zones of the ground waters and oil layers are found. Again while carrying out the said processes; it is benefitted from the movements of the rods and the current values measured by the device both from the surface and over the cable, because at each layer change, different electrical and magnetic fields will form on the contact surfaces of substances due to the potential difference.

Then, at the land where the oil search will be conducted, the land is scanned by rods from the surface, and faults, dykes, transpression zones and similar structures are located. Current values of the land are discovered. Subsequently, nails are driven to the necessary places, cable is laid (the amount of cable to be laid depends on the meters of depth that will be scanned), the user walks over the cable with the rods and determines all layers and thicknesses. Then the current values of these layers are measured and the shapes and features of the detected waves are determined. If values similar to the current values given by the oil are encountered and waves with similar features are caught, presence of oil is detected. Since this device detects data which come directly from liquid, it directly gives the depth and thickness of the oil layer. Just like it is done in water, start and end points of the oil layer are determined in a reliable manner by the movement of the rods, current values and wave shapes. Since the shapes of oil waves are different from water waves and mine waves, detection thereof is easier. This process is a method which is more inexpensive compared to the other geophysics methods, easy to apply and highly reliable.

7. Method of Elucidating Gelogical Structure and Geo-Chemical Composition of the Earth

This device can detect data at every depth of the ground with the cable method. Accordingly, if necessary, thousands of kilometers of measurement cable network can be established with an international cooperation including several countries. A stake is driven in at the point where measurement will be made and it is connected to the cable network. All layers are detected over the cable until the core of the earth. Current density values of each layer are measured meter by meter. Wave shapes and features of waves are determined. These current values and features of waves are compared with the current values and features of waves of mines and rocks and thus geochemical composition of each layer is determined. A suitable laboratory is established on the ground. According to the predicted and calculated pressure and temperature data at each depth of the earth; minerals, rocks, metals are subjected to these pressure and temperature values in the laboratory. The current values in connection with the energy emitted by them under these conditions are measured by the device. Wave shapes and features of the waves are determined. By comparing the data obtained from here with the ones obtained from the underground, the geological, geochemical, electrical and magnetic structure of the earth is elucidated in more detail. Moreover, much more detailed information can be attained about the structure of the core of the earth.

Furthermore, at specific points on seas and oceans, the measuring nail is dipped into the water on the surface, measuring cables are laid on the surface of the seas and oceans with ships and the cables are ensured to remain on the surface via materials like balloons. Afterwards, in depth current values of the seas and oceans are measured over this cable network and their wave shapes are drawn. Thus, information is obtained about layer changes, salinity ratios, warm and cold water streams, boundary surfaces of streams, depths and temperatures of seas and oceans by measuring current values, electrical and magnetic wave features.

8. Method of Measuring Current of Human Brain and Body

There occurs an electrical and magnetic field in the brain and bodies of humans and animals due to flow of blood. When measuring rods are held above a human head they intercross. By supplying current to the coils of the rods, the currents of the waves produced by the brain are stabilized. Thus the magnetic field force and the current density of the brain can be measured. Current of the other organs of the body are measured the same way. The highest current is measured at the abdomen and brain sections where there is the maximum movement in the body. Additionally, as it is explained in the section “the feature measured by the device”, shapes of the brain waves are drawn and the currents of each wave are measured separately. The measured current, number of waves, features of the waves provide information regarding the brain capacity and talents of an individual. Current values and features of healthy organs are recorded. When there occurs a disorder in the organs, their currents and features of waves are measured. Thus, diseases can be diagnosed from the changes in the currents and wave features of the organs. Moreover, micro-scaled rods are produced and veins are monitored therewith or a small conductive knob connected to the measuring cable is passed over the veins and monitoring is realized over the cable with the rods. Over the veins where blood circulation is healthy, the rods make their normal movements and show normal current values. Since movement stops when there is vein occlusion, movement of the rods also slow down and the current decreases. Thus, vein occlusions in the body can be diagnosed. However here, since the rods produce an electrical field in the opposite direction to the electrical field of the organ measured during the measurements, organs like brain and heart should not be subjected to this influence for a long time. Another problem is that fixed data can not be obtained since the overall energy changes in the world change the energy of the human body. For this reason, current change tables parallel to the energy changes of the world should be prepared and the diagnoses and treatments should be carried out accordingly. At this point, the following question can be raised: how will the current of the inner organs be measured? Answer: By the cable method. The values measured from the surface are the current of the organs which are nearest to the exterior of the body. A cable with a small metal part at the end thereof is used over the organ whose current is desired to be measured, where the metal part contacts the body, the cable is extended from the body at a distance corresponding to the depth of the organ within the body, then the current of the organ is measured on this distance and the shapes of the waves are drawn.

According to the results obtained from the experiments conducted after Jul. 13, 2007, as explained in the section “the feature measured by the device”, the inner structures of humans and animal organs are elucidated by wave detection method via the waves used to elucidate structure of the ground. For example, the probe of the measuring cable is connected onto a vein. Then the user walks over the cable with the rods. When other veins are encountered which intersect this vein, the rods intercross. Here, a different wave appears. Then this wave is rendered horizontal with the measuring cable and it is monitored. Subsequently, the waves intersecting this wave are rendered horizontal and monitored the same way. Thus, with a chain monitoring system, the inner structures of the living are elucidated.

The essence of this system is different from systems like NMR (Nuclear Magnetic Resonance) which takes a brain tomography, body graphics. In other magnetic systems, image of the brain and body are obtained by applying a strong magnetic field. The inventive system is based on detection of the natural electrical and magnetic waves emitted by the body and measurement of their current values and determination of the wave shapes and features.

In earthquake studies, it is observed that the counter waves produced via the substances which attenuate the earthquake waves decrease sexual potency of men. On the other hand, it is observed that the waves emitted by the substances strengthening the earthquake waves and some additional substances increase the sexual potency of men. Therefore the waves produced by substances produce certain psychological and physiological effects on human body. Certain treatment methods can be applied on humans by making use of these kinds of waves. Furthermore, certain sexual disorders can be treated with this method.

How can waves be applied on human body? There are several ways of application. 1—The measurement experiments are made by the person on whom the method will be applied. Thus the waves produced in the substances influence this person. 2—The material whose wave will be applied is kept over the person. The rods are oscillated by opening and closing on this material upon supplying current to the coils of the rods. Thus, the coils transfer the waves on the material to the body of the person. 3—The material whose wave will be applied is connected to one end of a cable. A small metal prop is connected to the other end of the cable. The metal prop is contacted from outside the organ on which the wave will be applied. The measuring rods are oscillated by supplying current to the coils thereof again over the material. The wave of the material is transferred to the organ contacted over the cable. 4—The material whose wave will be applied is contacted on the organ on which the wave will be applied. Oscillation is realized over it by the rods. 5—The material whose wave will be applied is wrapped around a sharp edged conductive rod. Its sharp end is directed to the person or persons to whom the wave will be applied. Oscillation is realized over the coils of the measuring rods and the said rod. 6—The wave shapes are determined by connecting a measuring cable to the organ on which the wave will be applied. A material is placed on the wave line. By realizing oscillation over the material upon supplying current to the measuring rods, the wave of the material is transferred to the wave of the organ. Thus, more local points can be treated. The same processes can be carried out by connecting magnets to the rods and oscillating the magnets over the material. Application can be realized by the said or similar methods. However at this point it should be kept in mind that during performing these kinds of processes, if there is a fault rupture near the building or land where the application is carried out, waves emitted from the materials may trigger artificial earthquake waves. Thus, preventive measures for the earthquake waves should be taken at the place where the application will be carried out.

9. Method of Examining Moon, Sun, Stars, Planets, Galaxies and Other Celestial Bodies

It was disclosed before that the feature measured in this system does not depend on the distance. Then it is possible to measure all kinds of celestial bodies and data related to the outer space.

The conductive nail or rod (61) connected to the measuring cable is exactly targeted to the celestial body whose electrical and magnetic field or energy value will be measured. The target is aimed with the rod at the end of the cable just like aiming a target with a shot-gun (FIG. 30). However, human body should not touch the conductive. More precise targeting is achieved by placing the targeting nail (61) in the center of a device like a binocular. The current of the targeted body immediately produces an electrical and magnetic field on the cable, and if the rods are held over the cable, they will intercross just like they do in detections of water, fault, mine. The current value of the targeted celestial body is measured by supplying current (16) to the coils at the end of the rods, just like it is done in detections of fault, water, mine. Thus data is obtained regarding the electrical and magnetic fields of the concerned body. The data obtained here is the data on the most outermost point of the body. In order to obtain in depth data, cable is extended just like in the measurements made on the ground, and in depth information is obtained about the celestial bodies like sun, moon which are measured over a cable starting from the targeting nail. With this system, information can be obtained also about the geological structures of the planets. It can be detected whether or not there is water, and even whether or not there are traces of life. For this purpose, a telescope (75) is used as an auxiliary tool. For example, if a planet (76) is being examined, a measuring nail is targeted on the more detailed points by a telescope (75) and thus data of more local areas are obtained. A broader, dish shaped antenna (72, 73 and 74) can be used here instead of the nail, but the result does not change. These data are compared with the data obtained on earth and the structures of the rocks are determined together with the fact of whether or not there is water. Energy values of the living creatures on earth are measured with this device, wave features are determined, it is searched if there are similar data on the monitored planets and other celestial bodies, and information is obtained concerning traces of life. With this invention, it becomes possible to discover whether or not there are traces of life in sun systems other than our sun system and even in other galaxies. The data obtained are converted via a suitable program into images on the computer by being compared with the substitutes on earth.

If in a scan, a larger area of the monitored celestial body is desired to be scanned, a large and broad disc (77) is made of a material which has a low electrification feature. Conductive nails (61) are mounted on this disc in certain distances. A separate measuring cable (37) is connected to each nail. Then the disc is mounted properly so as to move with the telescope. Additionally, a computer controlled activation system (78) is produced which will activate the telescope (75) and the disc (77). By conducting separate searches over the cables connected to each nail, a larger area is scanned at a time. Some data measured with this device is provided in FIG. 5.

TABLE 5
The measured celestial body Date Time Current (A/dm)

Sun 17.10.2006 14
Moon 26.02.2007 22:05 42.8
Moon 03.03.2007 21:40 207
Sun 15.04.2007 18:05 133
Sun 16.04.2007 09:25 132
Moon 23.05.2007 21:00 110
Planet Venus 23.05.2007 21:02 185
A random star 23.05.2007 21:06 104
A random star 23.01.2007 21:08 95
A random star 23.01.2007 21:15 460
* These measurements are not made very precisely. They are provided for information purposes only.

Electrical and magnetic fields of the celestial bodies are calculated by making use of these current values. Their structures are analyzed in three dimensions.

On the other hand, as it is explained in the section “the feature measured by the device”, the wave shapes of the waves coming from these bodies are determined over the cable. Features of these waves are determined. It is clarified whether or not there are traces of life there. More reliable data are obtained concerning their structure. Moreover, even a communication can be enabled between the celestial bodies by means of these waves.

10. Measurement of Current Values of the Living Such as Plants, Trees

The current values of plants are measured through the radiations from branches and leaves, by holding the rods over the plants and branches of trees. If the measurement is carried out by holding the rods below the branches, data about the tree can not be obtained. Data is obtained when the measurement is made by holding the rods over the branches. This situation shows that the radiations are emitted towards space. Results of some experiments conducted for this purpose are given in the below table:

TABLE 6
The measured plant Date Time Current (A/dm)

Branch of a chestnut tree
with a diameter of 3.1 cm 03.05.2007 15:02 2.3
A bank of roses 03.05.2007 15:04 3.5
A blossomed black cherry branch
with a diameter of 0.8 cm 03.05.2007 15:07 7
An apricot branch with
a diameter of 7.6 cm 03.05.2007 15:17 25
Newly blossomed peach tree 03.05.2007 15:35 10.5
A 5 year old pomegranate 17.05.2007 15:12 106
A mulberry branch with a
diameter of 0.5 cm 17.05.2007 15:29 102
Head of a cow (not a plant) 19.07.2007 128

If these current values are studied, it is understood that the current that trees bear have a great significance in rejuvenation thereof in the spring.

Productivity and diseases of plants, ages of trees are searched for by using these current values. Biochemical and biological events are elucidated upon the changes occurring in these currents. This invention will mark a new ear in agriculture. Additionally, wave shapes of all plants and animals are determined. Physiology of plants and animals are elucidated with these wave shapes. Their language is deciphered. Because each living creature gives its message by producing specific waves similar to the radio waves. The important thing is to reduce these waves to levels where humans can hear, see and listen to. That is, several design changes are made on radios and televisions and the sounds and images that are expressed by these waves are obtained. Thus, it is understood what the living creatures and substances intend to tell us.

11. Radar Method

The following experiment is made on a single cylinder air cooled diesel engine: After the engine is operated, when the measuring rods of the device are held over the engine it is observed that the rods intercross. Then, current is supplied (like in FIG. 17) to the coils of the rods so as to charge the rods with the same charge and the value of the wave emitted by the engine is measured. It is observed that the engine produces a current of 130-140 A/dm when it is running with full speed. When the speed is decreased the current value decreased as well. This experiment shows that a current is produced over moving machines and objects and a radiation occurs as a result of this. By making use of these features, the present device can also be used as a radar. For this purpose, a nail or an antenna (61) connected to the end of the measuring cable like in FIG. 32, is moved by a mechanical or electromechanical system (79). The measuring rods are held over the measuring cable in a parallel manner. When the nail or antenna encounters a moving object (airplane, helicopter, satellite, ship, a land vehicle, etc.), a current is produced in the measuring cable and the rods move. The current value of the object is measured (16) by supplying current to the coils of the rods.

With this system, even the airplanes that are not caught by radars are located by these kinds of radars, because if the airplane is moving, it will emit a specific wave. For the airplane not to emit a wave, it should not be flying. If it is flying it will be caught by these kinds of radars anyway. In fact, since waves of these kinds of airplanes are special, it will be easy to catch them. The current value of each vehicle is determined in advance according to its speed and type. Then identities of the flying objects are detected (80) according to these current values by the radars. If a semispherical (81) antenna is connected to the measuring cable, since there will be an opportunity of scanning a larger area, objects are detected more quickly. The bottom of the semispherical antenna is isolated to prevent receiving waves from the below.

Not only the air vehicles but also the sea and land vehicles are also detected with this system.

If the measurement is made while holding the rods below a flying object, no data will be able to be obtained. However, if the object is aimed with the nail or antenna connected to the measuring cable data is obtained. This situation shows that the direction of the produced waves is towards space. The fact that when the nail is aimed at the vehicle it draws the waves onto itself, shows that these waves exhibit electrical and magnetic features, because the conductive rod can attract these waves like a magnet and collect them thereon.

The difference of this system from the other radars is that radar waves are produced in the other radars and detection is made according to the reflection of these waves from objects such as airplane, ships. While in this system, no wave is produced. Waves produced by moving objects are caught and detection is made.

Results of some experiments conducted for this purpose are given in the below table:

TABLE 7
Air vehicle Date Current (A/dm)

A big passenger airplane flying at a high altitude 17.05.2007 120

This system is applied in a different way as follows: Non-conductive stakes (82) are driven in at a high point in the land like in FIG. 33. Nails or conductive rods (61) are connected to on these stakes in different directions. Here, the reason of connecting nails in different directions is to determine from which direction the monitored vehicle is coming. Here, instead of nails or rods, antennas of different shapes are also used. However, objects with sharp ends are preferred since they detect these kinds of waves better. Measuring cables (37) are connected to the nails. Control is performed over the cables by means of the measuring rods (15). When a vehicle enters the zone of influence of the nail or rod (80), the measuring rods start to intercross over the cable (15). At the same time, current of the object is measured and wave shapes are determined and predictions are made regarding the vehicle. As a result of experiments conducted this way, big passenger airplanes have been detected 10 minutes before they reach the radar point. That is, the airplane has been detected at a distance of about 150 km. The object remains under the control of this nail until it reaches the peak point, after it passes the peak point it goes under the control of the nail in the other direction. A 300 km diameter area of can be controlled with such a simple radar. Of course, the control distance is also determined by the structure of the land. If there are high mountains around the radar, these mountains form a cover and this situation reduces the zone of influence. The higher the point the radar is established, the more the zone of influence will enlarge. In the experiments, vehicles passing on a nearby road have also been detected when entered into the area of view of the nails. For that reason, rockets which are not caught by the other radars by flying from a low altitude, are spotted by these kinds of rockets.

In these kinds of radars, in order to enlarge the zone of influence of the radar, horizontal conductive rods (83) are disposed on high hills at certain distances from the central radar. Then, the nail of the central radar in the concerned direction is adjusted to see the rod on the said hill. Thus, zone of influence of the radar is enlarged. Suppose that such a nail or rod is disposed at a hill 150 km away from the central radar, and this rod detected a distance of 150 km away from it. The nail of the central radar detects the 150 km, thus the zone of influence is increased to 300 km. This way, the zone of influence is increased as desired.

In such radars, in order to increase the influence of radar against objects flying from a low altitude, antennas are arranged at certain spots in the blind regions in the zone of influence of the radar so as to control the land. The cables connected to these antennas are extended to the high points. A conductive material is connected to the end of the cable at the high point. Then, a contact is established between this conductive and the antenna (nail or rod) of the radar at the said direction.

12. Method of Analysis of the Chemical Compositions of Substances and Rocks

Sometimes it is observed that the rods remain parallel to each other at different current values at a point where the measurement is being made or over a substance. The following result is derived from this situation: there are minerals and structures that radiate at different values at the same place or in the same substance. For example a measurement is conducted on an ore sample and different current values are obtained. These current values are compared with the current values of known pure minerals. Thus, predications are made related to the types of minerals or elements inherent in the structure of the ore. This kind of analysis provides information of more than 50% although not 100%.

The ability of fabrics like wool, satin, and substances like rubber to stabilize different current densities, originates from the fact that each functional group and each chemical bond structure within the structure of organic compounds radiate at different values. Accordingly, the currents depending on the radiations of each functional group and bond structures are detected. Then with these current values, the structures of compounds whose structures are not known are elucidated.

Furthermore, as a result of the experiments explained in the section “the feature measured by the device”, these analyses are further clarified as the wave shapes are determined and their currents are measured.

13. Measuring the Current Passing Through the Power Lines

Since the present device detects the current passing through the power lines (as it is explained the earthquake detection section), both the cable lines that pass through underground are detected and the current intensity that passes through the lines, be it overt or hidden, are measured with this system. The measuring rods are held over the line and currents thereof are measured (like in FIG. 17). If the line travels from above, the nail connected to the measuring cable is aimed at the line and the current is measured over the measuring cable. If it passes inside a wall, the nail connected to the measuring cable contacts the wall and again the current is measured over the measuring cable.

The Feature Measured by the Device

The feature measured by the device is the polarized radiation or waves which form electrical or magnetic fields therearound, and disperse in the space lineally. These waves are similar to electromagnetic waves in the sense that they exhibit the feature of a wave. However some of their characteristics differ from normal electromagnetic waves. For example a normal electromagnetic wave is not affected by electrical or magnetic fields. The said waves both affect and are affected by electrical or magnetic fields. Supposing that the said waves are electromagnetic waves comprised of charged particles such as cosmic rays, the materials forming the said radiation should be subject to loss of mass or certain changes by time. It is explained in the specification that each material has a specific radiation. For example, a radiating piece of gold should undergo a loss of mass by time if it is cosmic radiation or it should become a + charged ion clew if it is a secondary beta (electron) radiation since it will lose its electrons by time, or it should collect the electrons that it has lost and thus form a current therearound. Currently, no such event has been observed in daily life. Accordingly, waves measured by the said device differ from the electromagnetic waves defined until now. Now we will describe the said waves by scrutinizing the results of the experiments.

The following experiment shall be conducted: When measuring rods are held above a cable carrying a current to an electrical motor or a device, the rods are observed to be crossed. The rods are balanced in parallel position upon supplying current to the coils of the rods and the current is measured as A/dm (like in FIG. 17). Subsequently the current drawn by the device is measured. It is observed that the current of A/dm which stabilizes the rods is approximately equal to the current drawn by the device. If the measurement is carried out by lifting the cable in the air and similarly holding the rods below the cable, no data can be obtained pertaining to the current passing through the cable. The result of the said experiment is as follows: there is radiation towards space via the cable. In effect, it is a physically known fact that sinusoidal currents and accelerated particles form radiation. However the rays measured by the said invention system form an electrical and magnetic field therearound. Indeed, it is known that, according to the wave equations of Hertz and Maxwell, there is a magnetic field and an electrical field orthogonal to each other which accompany an electromagnetic wave. However the said waves do not form an electrical or magnetic field therearound.

When the current value of the sun is being measured, it is observed that the values of the current measured upon connecting a large tray to the end of the measuring cable and holding it against the sun, the current measured upon connecting a nail to the end of the cable and targeting the sun, and the current measured upon connecting a needle to the end of the cable and targeting the sun are the same. If the value of the normal electromagnetic wave emitted by the sun is measured, since the tray will collect more radiation, a bigger current value should be attained. However it is seen here that the surface is not important. Thus, the waves measured by the inventive device spread lineally and can be collected by the end of a needle or nail. To be more precise, since the said rays have electrical and magnetic properties, rays at a specific distance head towards a nail or needle like a magnet. Again when the measuring nail is targeted to certain stars and their currents are measured, it is observed that the measured current values are high such as 95 A/dm, 185 A/dm, 460 A/dm. These values are astonishing when it is considered that even the nearest star is a few thousand light-years away. These experiments show that the said rays are not affected by distance.

Where the energy of a fault is measured, no movement is observed in the rods until the fault rupture is approached. When it is approached to the fault, activation starts and the maximum movement is observed on the fault rupture line. That is to say, the rays emitted from the faults do not get scattered around much. This event demonstrates that the rays are emitted towards the space along the fault plane. In other words, the said rays are polarized and they are emitted along a plane.

When measurements are made over metals, alloys, fabrics, rubber, plastics, rocks, minerals, plants, animals, people, it is seen that each substance and living creature has a unique current value and a radiation related thereto. Suppose that when the device measures the current value of the stars, it catches the cosmic rays coming from the stars. Since cosmic rays are high energy rays, they produce the necessary electrical and magnetic influence on the rods and enable movement of the rods. In this case, how will the magnetic rays emitted by the substances on the earth be explained? For example, a satin fabric may emit radiation in fairly high values and each substance emits radiation more or less. In this case, either the substances emit cosmic rays which are not discovered until now, or they emit magnetic and electrical rays different from the known rays. Although it is a known fact that substances radiate, these are normal electromagnetic waves which have electrical and magnetic fields perpendicular to each other.

Waves emitted by some substances are attenuated by the waves emitted by some other substances. For example a fabric like satin has the feature of balancing as much current as is supplied to the coils of the measuring rods. This means that such substances can emit waves of very different frequencies and wavelengths. Furthermore, a fabric such as silk, has a low current density. If a silk fabric and a satin fabric are placed side by side in contact with each other and a measurement is made, a low current density will be obtained. That means that the waves emitted by the silk fabric attenuate the waves emitted by the satin fabric.

The following comment can be made according to the results of these experiments: the waves measured by this device are waves which exhibit an electrical and magnetic feature different from the known electromagnetic waves and cosmic rays. Substances, while emitting normal electromagnetic waves, proportionate to the energy amount they bear, they also emit electrical and magnetic waves. There are waves that accompany these rays, exhibiting an electrical and magnetic feature. Thus, these waves produce an electrical and magnetic field around them at the route that they are traveling.

These waves also have the feature of dimension jumping. For example, in detection of ground waters or layers of the ground, data relating to the underground are reflected on separate sections on the measuring cable connected to the nail driven to the measuring point. That is to say, if there is a current of 1 A/dm in the first 10 m of the ground, 1 A/dm current is measured in the first 10 m of the cable. If there is a current of 20 A/dm in the 10-30 m of the ground, 20 A/dm current is measured in the 10-30 m of the cable. The cable receives these data from a single point. In this case, the same data needs to be measured at every point of the cable. Since different data are obtained at different sections of the cable, these waves can jump over each other on the same conductive and settles at the equivalent regions. The following objection can be made at this point: the electrical and magnetic field under ground produces an equivalent field to itself on the cable with induction starting from the point where the nail is driven. It can be responded as follows to this objection:

1. When the nail is lifted 10 m high and pointed downwards at the point where the measurement is being made, the same data are obtained regarding the same point. Here, contact with the ground is broken and the influence of induction is partially reduced.

2. When currents of the stars are being measured, since there is a distance of thousands, millions of light years, if these waves travel this distance and arrive, they will decrease, scatter due to the obstacles they will encounter like normal rays and very little of their influence will reach the earth. Since stars could give more current than even the sun which is the nearest star to us, the currents arrive at the earth without a loss; that means that they dimension jump.

3. It is determined by experiments that human brain also emits this kind of waves. I presume that human thought is comprised of this kind of waves. When the speed of thought is considered, there is not a concept of speed for thought. There is a concept of moment. Human mind is at the deepest point of the space at one moment and beyond the dreams at another moment. There is not a time lag when the brain is realizing these. It reaches everywhere in one moment. In this case, it can be said that human thought also dimension jumps and reaches everywhere. If thee is no mistake in these foresights, there will be the opportunity of obtaining information regarding the present conditions of bodies that send us information from very far away. For example, the present status of a star which sends us light from a distance of two hundred million years will be learned instead of its status of two hundred million years ago.

These waves have the feature of screening. For example, when the ground waters are being detected, the current of the uppermost water layer is measured from the surface. The currents of the lower layers can be measured only when a nail is driven and a measuring cable is connected to it. Accordingly, the current of the upper water layer screens the lower layers. And the data obtained concerning the celestial bodies such as stars, planets, are related to their outermost magnetic and electrical structures.

All data obtained with this system are converted to images in the computers with appropriate programs, and images of the systems that are measured are obtained. Or a television or a radio can be designed in accordance with these waves and images are obtained and sounds are heard.

This invention explains the magnetism of the earth, planets, stars and similar celestial bodies. When measurement is being made by holding the measuring rods over a conductive carrying current, since the value measured in A/dm is approximately equal to the intensity of the current passing through the conductive, we may accept that the A/dm value obtained in the other measurements is equivalent to the current produced there. Accordingly, more or less one current is produced around all bodies and substances which are moving and oscillating. If there is a current, then there is a related electrical and magnetic field. Furthermore, there is also current in bodies and substances which are not moving. The origin of this current can be partly rotation of the earth around its axis and partly oscillation of the atoms and molecules of the substances, movement of the electrons comprising a structure of crystal cage, and the nuclear magnetic resonance that results from oscillation of protons and neutrons.

In conclusion, current is produced as a result of the rotation of the earth around its axis and around the sun. Rivers flowing on the surface of the earth, ground waters, waves of the seas and oceans, the streams in the seas and oceans, winds, fires, mines, oil reservoirs, movement of the magma under the earth crust, earth core. Finally, the product of all these factors produces the magnetism of the earth. Similar formations are also valid for the other celestial bodies. The attraction powers between the earth and the other celestial bodies should be recalculated after this invention.

The following experiments were made since Jun. 13, 2007:

There was data related to the approximately 60 m deep water well drilled before, regarding its water level, thickness of the water layer, vertical and horizontal rupture systems of the point where the well is drilled, rock structure and water flow rate. A measuring nail was driven at the entrance of the well and a cable of about 80 m connected to the cable was laid. Then the user walked over the cable with the measuring rods and the upper and lower points of the water layer and the horizontal layers in between are marked on the cable by means of the intercrossing of the rods. Afterwards, the user walked to right and left perpendicular to the cable in order to find out the distance that the electrical and magnetic field produced on the cable affects at the right and left of the cable and to determine the shape of this field. The points where the rods intercrossed (15) on the right and left of the cable were marked like in FIG. 34. When these points were connected, the shapes of the waves (84) flowing through the cable came to view. Or the paths that the electrical and magnetic current followed appeared in the shape of waves. At the starting depth of the water layer, two waves begin reciprocally at the same point on the same plane; these waves return from the depth where the water layer ceases and combined with the wave in the opposite direction (88). Some waves after returning come lineally and combine with the starting point (8). Considering the measuring cable as the horizontal axis, the waves flow from the right and left of the cable. The electrical and magnetic components of the horizontal water layer intersect the measuring cable perpendicularly and open towards right and left (85). Rods intercross at the right and left of the cable along this linear line (85). This line constitutes a wave screen perpendicular to the ground plane. That is to say, the horizontal lines under ground become vertical above ground. How were the waves of these vertical lines monitored? This time, perpendicular wooden stakes (82) were driven in parallel to these screens. Nails (61) were connected to the top of these stakes so as to be perpendicular to the electrical and magnetic screen. The cables (37) connected to these nails were laid towards the opposite direction whereby the screen in the vertical position was brought to the horizontal position. In the horizontal position, the shapes of the waves on these fields were determined (93).—At anywhere on the wave line, the measuring rods are held over this line and the current of the wave is measured by the device. The current of each wave is measured on its own line, thus the current of each wave is measured separately.—This way, shapes of four waves were determined at the vertical component of the well. There were several other waves but their shapes were not determined. All the waves in FIG. 35 were determined on the same cable axis. But they were drawn separately to prevent them from getting mixed up. These waves and the subsequent waves are drawn off-scale. A vertical component (98) of these waves was detected the same way on the cable axis. In other words, these waves are comprised of two components perpendicular to each other. Although they look like electromagnetic waves in terms of shape, both components of these waves exhibit both electrical and magnetic features. These are like electromagnetic waves on which electric current is imposed. Currents of these waves were also measured. Current of wave No. 1 (88) in FIG. 35 is measured as 22 A/dm, current of wave No. 2 (89) as 43 A/dm, current of wave No. 3 (90) as 63 A/dm, current of wave No. 4 (91) as 12 A/dm. It is observed that these waves traveled at the section in between the 7.5 m and 60 m depths of the well, which bore the water of the well. Shapes of two waves (99 and 100) were determined at the horizontal water layer in the 16th meter of the well. Current of the wave (99) among these waves is measured as 75 A/dm. Only the current of the horizontal layer at the 22.6th meter of the well was measured, and it was found to be 105 A/dm. When the shapes of the waves were being determined, the points where the rods intercrossed were marked with materials like stones, trees and were measured with a measuring tape. Thus the measurements are not very precise or millimetric. For that reason, some deviation occurs at the lengths and amplitudes of the waves. However, their shapes and sizes are given to facilitate understanding of the subject. If the end of the cable which is not connected to the nail is not isolated and it contacts the ground, these shapes can not be monitored. This time, the rods open at the points where they intercross. This means that in this case, since the current completes the circuit via the ground, the electrical and magnetic field is lost in this area where only the normal electromagnetic radiation remains. When the cable end is isolated, the current returns on the cable that it arrives, thus the waves can be monitored. That is, the cable somewhat detains the waves thereon.

Following these experiments, experiments concerning the waves of different materials were made. The nail of the measuring cable was contacted with a golden bracelet (101) and the shape of the wave was determined over the cable (102). The same process was performed over a graphite piece and a graphite wave (104) was obtained. These waves do not comprise only the delineated waves. The delineated wave is the outermost, big wave. In some substances, these waves are followed by smaller nested waves. When the same experiment was made on the rubber piece, nested waves occurred at the right and left of the cable, at a width of 120 meters, 60 m to the right (106) and 60 m to the left (106) of the cable (37) as in FIG. 41. Approximately 95 waves were detected at both right and left of the cable. When the same process is carried out with satin fabric, 23 nested waves were detected on each side of the cable again at a width of 120 m. In the experiment made with the sheep wool, at a width of 38+28=76 m, it was detected approximately 18 waves on the right and 18 waves on the left reciprocal to each other. These reciprocal waves are a continuation of each other. These waves also have a vertical component. Numbers of waves are not limited with the given ones. These are the ones which could be detected. Then a golden bracelet was placed on the rubber piece, the nail of the measuring cable was arranged to contact both of them, control was performed and it was observed that except for the wave over the cable, the other waves of the rubber disappeared. That is, the waves of the gold attenuated the waves of the rubber.

A similar experiment was made on the human brain. Approximately 72-85 nested reciprocal waves were detected, varying according to the individual, at a width of 200 meters, about 100 m to the right (106) of the cable and 100 m to the left (106) of the cable. These reciprocal waves are a continuation of each other. Numbers of waves are not limited with these. These are the ones which could be detected. Additionally, these waves have that many vertical components. In other words, a human brain influences a 200 m diameter area of 31,416 m², a volume about 3,000,000 m³. Waves of rubber, satin, wool and human brain are similar to each other.

A similar experiment was made on a thin and young branch of pomegranate. A wave (107) with a period of about 68 m and amplitude of about 19 m was detected. The waves given in FIG. 43 were obtained in the experiment made on the diesel sample.

When the shapes of the waves are being determined, the cable is properly laid on the land. One end of the cable is contacted with the object whose wave is being determined and the other end is isolated. The waves of the object which are normally towards the space are thus brought to a horizontal position and are enabled to be monitored.

The results of these experiments have proved the theoretical foresights disclosed in the specification. These results of the experiments have demonstrated that these waves exhibit electrical and magnetic features, because the conductive connected to the end of the measuring cable can draw the waves that are far away and collect them on the cable. On the other hand, the waves can be transferred to any desired direction via the cable. That is to say, they can flow like an electric current connected to a cable. Since the plane of these waves can be changed via the cable, it is clear that they are polarized. It is also understood that these waves are different from normal electromagnetic waves. Since the wavelengths can be expressed in meters, it may be said that they are radio waves. However, it is known that in normal electromagnetic waves, as the length of the wave increases its energy decreases. However, upon examining Table 8, it is seen that the current carried by these kinds of waves increase proportionate to the increase in wavelength or period. The invention has acquired a new dimension with the results of these experiments. Certain problems described in the specification have been solved. For example, in treasure, mine, water detections, substances which give similar values of currents can be identified by determining the wave shapes and by means of their differences of wavelengths, amplitude, frequency, period, etc. The problem of detecting water during earthquake or similar activities has been eliminated with the help of the differences between the waves of water and earthquakes, upon determining the shapes and sizes of the earthquakes. For example in these experiments, when a process of attenuating the earthquake waves was performed at the entrance of the experiment well, it was observed that the horizontal wave (99) at the 16th meter disappeared for a period of time.

Until these experiments, earthquakes had been monitored by measuring current changes. After there experiments, they are monitored also by means of the features such as wave shapes and the wavelengths, amplitudes, frequencies, periods of the waves. Especially in the sequential earthquakes, after an earthquake takes place, the features of the waves of this earthquake are determined. After that, the waves of the new earthquake are determined. Thus, more reliable predictions can be made regarding the time, size and location of the earthquake.

These experiments also explain the movements of the measuring rods. Since these waves exhibit electrical and magnetic features, when the rods come over the waves, as they will naturally prefer the path where resistance is the least, they will start to flow over the rods. Since the electrical field of the waves charges the rods with opposite charges (FIG. 13), the rods attract each other. Thus the rods intercross and short circuit occurs. Accordingly, the point where the rods intercross gives the line where the wave flows. When the rods are mounted on the bearings, there does not occur an activation as distinctive as when it is carried with hands, because in this case the waves short circuit. For this reason, the bearings are mounted on different isolator trays and by placing an isolator screen between the two bearings this problem is partially eliminated.

With these experiments, the under ground can be monitored in three dimensions from a point. For example, when the wave screen of a horizontal layer under ground, which becomes vertical above the ground, is brought back to a horizontal position (93) with the cable, upon walking over this horizontal wave axis, the rods intercross (15) at distances where there are the vertical ruptures (94) that intersect this layer. Thus, the vertical ruptures that intersect the horizontal layer and the formation limits are determined. Again, nails connected to the measuring cable are pointed towards these waves in vertical position and they are brought back to horizontal position. This time, shapes and currents of these waves are detected. Then, a successive scanning is performed on a very wide area rather than a point and the results are obtained. The boundaries of the waves of this horizontal layer are not limited with the length of the cable. They continue on the earth depending on the length of the horizontal layer, even after the cable finishes.

These waves can be detained on a cable. For example, when the end of the nail contacted with an object whose wave is detected is being held in contact with the object, the nail is wrapped around with an isolating tape. Upon reaching the end, when the end of the nail is also covered in one move, the waves are detained within the cable. When the tape wrapped around the nail is removed, the waves disappear.

TABLE 8
Features of some of the detected waves: Origin
of the wave Average period Amplitude Current
Period + (Meter) (Meter) (A/dm) 2xAmplitude

Experiment well wave No. 1 (88) 18.3 1.6 22 21.5
Experiment well wave No. 2 (89) 35.5 2.8 43 41.1
Experiment well wave No. 3 (90) 52 5.5 63 63
Experiment well wave No. 4 (91) 13.4 3.7 12 20.8
Experiment well horizontal wave (99) 58 9 75 76
Gold wave (102) 6.8 1.6 6-7.5 10
Graphite wave (104) 6.4 3 8-13.5 12.4
Pomegranate tree wave (107) 68 19 106 106

When the table is reviewed, it is seen that the sum of the period and two times the amplitude of the waves is near the numerical value of the current in decimeter.

If a nail (36) is immersed in the water flowing from a faucet (109) and a measuring cable (37) is connected to this nail, linear DC current waves (110) are produced at the right and left of the cable. If the nail is not immersed in the water but held up a little high, the waves will be intermittent (111). According to this experiment, it is understood that a great majority of the waves obtained from both the ground waters and the other materials are DC current waves.

When a big passenger airplane caught by the radar system given in FIG. 33 was within the influence zone of the radar, the waves of the airplane were detained within the cable upon slowly wrapping the end of the nail with an isolating tape and then the shape of the waves (112) were determined. Of course these are only the waves that could remain on the cable. The number of waves is not limited with these.

In addition to being able to be detained within cables, such waves can also be detained in hoses filled with water, ground waters in the faults, blood, and similar structures. Since each wave has a wave which destroys it, these detained waves can be attenuated by sending their opposite waves onto these waves.

It is also understood that the current produced in earthquakes accumulate within faults and ground waters in the form of such waves.

The present invention and experiments also describe the effects of earthquakes. For example, since the in-depth water thickness in the faults is small, less earthquake waves are stored. Since width of the horizontal faults is larger, more water is stored in the horizontal lines, accordingly more earthquake waves are stored. For this reason, the destructive effect of horizontal S waves is more than the one of vertical P waves. Furthermore, it is thus understood why the earthquake damage is more at the alluvial lands where ground waters are close to the surface and are abundant.

Considering the sensational news regarding using electromagnetic guns in some wars whereby the soldiers of the opposite side are demoralized, the waves used could be the said kind of waves. In this case, people who have been exposed to such a psychological syndrome, are checked with the system of this invention and the waves in their bodies are detected. If waves other than the normal waves are detected in the body, the waves which will destroy the detected waves are determined. The people will be psychologically treated by sending the said destroying waves thereto. At the same time, the harmful waves will be determined and defense systems will be formed against such probable attacks in a war.

Obtaining Big Waves

A measuring cable (37) is connected to a sample (113). The shape of the wave produced by the said sample is determined by the measuring rods (114). Stakes (82) are driven in across the peak points of the waves (Preferably wooden stakes). Horizontal nails (61) are connected to these stakes such that the sharp ends of the stakes, will aim the peak points of the waves. Measuring cables (37) are connected to the nails. The other ends of these cables are connected (117) at the end portion of the wave with the end of the measuring cable connected to the sample. A bigger wave (115) is produced starting at the point where the ends are connected. When the same processes are performed on this second wave, a bigger wave (116) is obtained. By carrying on these processes continuously, increasingly bigger waves will be obtained. Carrying out the connections at the first or second peak points does not change the results. For example in such an experiment made on an iron manganese ore sample, current of the first wave (114) is measured as 27 A/dm, current of the second wave (115) as 105 A/dm and current of the fourth wave as 450-500 A/dm. The second way to obtain such big waves is as follows: different samples are taken from the same substance, a separate cable is connected to each sample, the other ends of the cables are connected to each other where the waves cease to exist, and bigger waves are obtained. During these experiments, it was observed that artificial earthquake waves were triggered in the land, and after the experiments, processes for destroying the earthquake waves were performed and the conditions were returned to normal.

Such big waves can not be obtained by connecting the peak points of the waves of substances like rubber, satin, wool. This means that such reciprocal waves are not different waves, but the departure and return of the same wave. In order to obtain bigger waves from these cables, different samples are taken, separate cables are connected to each of them, the other ends of these cables are connected to each other where the waves cease to exist, and bigger waves are obtained. For example, current of the outermost wave of the rubber waves was measured as about 428 A/dm; when the waves of two rubber samples were connected to each other, a wave with a current of 800 A/dm was obtained. Thus, by combining waves of substances, bigger waves are obtained.

The same results can be achieved by performing the experiments such as determining the shape of the waves, measuring currents thereof as explained in the section “the feature measured by the device”, with coil wires, measuring hoses filled with water, fiber optic cables used as alternatives to the cable.

14. Communication Method

The waves produced in this system are used for communication purposes. It is determined in the experiments made that human speech, voices of animals, television and computer monitors produce similar waves. Shapes and currents of the sound waves and image waves are determined. Then, farther objects and living creatures are aimed with measuring nails and cables. Currents of the waves produced over the cable are measured and features thereof are determined and thus the speeches thereat are identified and the images obtained. Or communication can be provided by making a change in the design in radios and televisions according to these waves. With this system, not only what humans intend to tell is analyzed, but also what other living creatures intend to tell. Since these waves have the feature of dimension jumping; communication between planets, stars, galaxies can be attained with these kinds of waves. In this system, since the natural waves emitted by the living and the substances are used, there is no need for transmitter stations. Since these waves are emitted towards space, with the purpose of ensuring that they are transferred to another place, by bringing them to the horizontal position with the measuring nails, rods and cables, and disposing horizontal conductive rods and cables in certain intervals at points on earth which face each other, it is ensured that they are transferred from one place to another.

### REFERENCE LIST

1—Handles of the rods
2—Counterweights
3—Coils
4—Rods and showing the rods briefly schematically
5—Winding the coils longitudinally
6—Connection cables
7—Bow-shape of the rod
8—One of the shapes of parallel connection
9—Bearings
10—Spring or pendulum
11—The tray where the bearings are connected.
12—Conductive coal rods
13—Conductive tray from which the conductive coal rods receive current
14—Mini ball-bearings
15—Briefly showing scanning of the measuring device (intercrossing of the rods)
16—Briefly showing current measurement of the measuring device (FIG. 17)
17—Hands holding the rods
18—Hands and bearings holding the rods
19—Ammeter
20—Current controller
21—On/Off switch
22—Batteries and accumulator
23—AC or DC current transformer
24—Automatic current controller
25—Programmable electronic brain
26—Electronic circuit which transfers the current values to the computer
27—Computer
28—Coil cooling system
29—Sensors
30—Fault ruptures
31—Fault width
32—Fault direction
33—Oscillation directions of the rods
34—Distance between the rods
35—Vertical component of the fault rupture
36—Measuring nails
37—Measuring cables
38—Fault's active depth at the point where the rods intercross
39—Fault's active depth at a different point
40—Above ground
41—Vertical section of the ground
42—Horizontal distance between the place where the nail is driven and the point where the measurement is made
43—Altitude difference between the place where the nail is driven and the point where the measurement is made
44—Measured actual depth of the place where the nail is driven
45—Water level
46—Depth where the water starts
47—Depth where the second aquifer layer starts
48—Depth where the third aquifer layer starts
49—Depth where the water layer ends
50 —Layer above the water
51—First aquifer layer
52—Second aquifer layer
53—Third aquifer layer
54—Impermeable layer
55—Ground water reservoir in the form of a pond
56—Boundaries of the ground water reservoir in the form of a pond
57—Starting depth of the ground water reservoir in the form of a pond
58—First aquifer layer of the water in the form a pond
59—Second aquifer layer of the water in the form a pond
60—Boundaries of the underground river
61—Direction (target) rod or nail
62—Direction trays
63—Depth at which underground river flows
64—Depth of the underground river
65—Direction of the underground river
66—Test for flow direction of the underground river
67—Period until when the current remains constant the first time in earthquakes.
68—Time of the earthquake
69—Boundaries of the mine lens (head)
70—Depth of the mine
71—Thickness of the mine lens
72, 73, 74—Different types of antenna
75—Telescope
76—Planet
77—Wide diameter scan disc
78—Computer controlled activation system for the telescope and the wide diameter disc
79—Activation system for Radar
80—Flying object
81—Semispherical conductive antenna
82—Stakes
83—Conductive rod placed at a far hill
84—The wave curve which connects the points where the rods intercross
85—Line of the vertical wave screen of the underground horizontal water layer
86—Upper level of the water layer in the experiment well
87—Lower level of the water layer in the experiment well
88—Wave No. 1 obtained in the experiment well
89—Wave No. 2 obtained in the experiment well
90—Wave No. 3 obtained in the experiment well
91—Wave No. 4 obtained in the experiment well
92—Wave screens
93—Examination of wave screens in horizontal position
94—Axis of the rupture wave that intersects the horizontal wave perpendicularly
95—Imaginary horizontal axis of the sample whose wave is determined perpendicular to the measuring cable
96—Imaginary vertical axis of the sample whose wave is determined perpendicular to the measuring cable
97—:Horizontal component of the wave
98—Vertical component of the wave
99, 100—Waves of the horizontal water layer at the experiment well
101—Golden bracelet
102—Gold wave
103—Graphite sample
104—Graphite wave
105—Sample whose wave is determined
106—Width at which the waves are arranged
107—Wave of the pomegranate tree
108—Diesel sample
109—Faucet
110—Linear DC current wave
111—Intermittent DC current wave
112—Waves of the big passenger airplane
113—Wave origin
114—First wave forming over the sample
115—Second wave obtained by interference of waves
116—Third wave obtained by interference of waves
117—First point where the cables are connected
118—Second point where the cables are connected
119—Winding of coils around a ring
120—Winding of coils around a disc
121—Different shape of the measuring bow
122—Flat shape of the measuring rod

### FIGURES

FIG. 1, 2, 3, 4, 5 show different forms of measuring rods. Handle parts (1), counterweights (2), coils (3) wound around rods, winding of the coils longitudinally (5), rods (4).

FIG. 6 shows the bow shaped measuring rod. Rod (7), connection cables (6), coil windings (3).

FIG. 7 shows connection forms of coil wires wound around rods. Connection cables (6), coils (3), a form of parallel connection (8).

FIG. 8 shows a form of bearing for rods and a different connection form for rods. Handle (1) of the rod, bearing (9), coil (3), counterweight (2), spring or pendulum (10), tray (11) to which the bearings are connected, conductive coal rods (12) rotating with the rods, conductive tray (13) from which the coals receive current by rubbing against it, connection cables (6), mini ball-bearings (14).

FIG. 9 shows the schematic view of the rods and the device. Rods (4). Schematic view of the usage forms of the device. Scanning form (15), forms of measuring current (16) (brief schematic view of FIG. 17).

FIG. 10 shows a form of connection of the rods to the bearing. Handle of the rod (1), bearings (9), coils (3), counterweight (2) for the rod, spring or pendulum (10) which keeps rotation of the rod in balance, tray (11) to which the bearings are connected.

FIG. 11 shows a form of holding the rods in hands. Handles of the rods (1), hands (17), coils (3), connection cables (6).

FIG. 12 shows the measuring circuit of the device. Measuring rods (4), connection cables (6), coils (3), ammeter (19), current controller (20), on/off switch (21), power supply: Battery or accumulator (22), hands or bearings (18) holding the rods, AC or DC current transformer (23).

FIG. 13 shows distribution of charge on the rods entering a regular electrical field perpendicularly.

FIG. 14 shows the form of the device which is designed for measuring stations. Measuring rods (4), coils (3), sensors (29), power supply (22), automatic current controller (24), ammeter (19), programmable electronic brain (25), electronic circuit (26) which transfers the currents measured in the ammeter to the computer, computer (27) which controls the system and records and graphs data, water spraying system (28) for cooling coils, AC or DC current transformer (23), on/off switch (21), hands or bearings (18) holding the rods.

FIG. 15 shows schematic view of the measuring device detecting the geological fault. Fault ruptures (30), fault width (31), measuring rods (15) intercrossing over the fault ruptures.

FIG. 16 shows schematic view of the movement of the measuring rods in the geological fault direction. Fault ruptures (30), fault direction (32), oscillation directions (33) of the rods, rods (4).

FIG. 17 shows measurement of the fault's current as a circuit. Fault rupture (30), measuring rods (4), coils (3), hands or bearings (18) holding the rods, ammeter (19), current controller (20), on/off switch (21), power supply: battery or accumulator (22), AC or DC current transformer (23), adjustment of the distance between the rods (34).

FIG. 18 schematically shows dip directions and active depths of faults. Vertical component of the fault rupture (35), nails (36) driven on the surface of the land, measuring cables (37), fault's active depth at the point where the rods intercross (38), fault's active depth at a different point (39), measuring the current at the said depth with the device over the cable (16), intercrossing of the rods over cable at the depth where the fault is active (15), above ground (40), vertical section of the ground (41).

FIG. 19 schematically shows measurement of the depth of the point where measurement is carried out over the cable. Measuring cable (37), measuring nail (36), above ground (40), measurement with the device (16), horizontal distance between the place where the nail is driven and the point where the measurement is made over the cable (42), altitude difference between the place where the nail is driven and the place where the measurement is made (43), measured actual depth of the place where the nail is driven (44).

FIG. 20 shows schematic view of the condenser model of the faults. Vertical component of the fault rupture (35), distribution of charge (+ and −) at the level of the fault where there is water, water level (45), above ground (40).

FIG. 21 shows schematic view of measurement of the depths and thicknesses of water layers on a fault line over a cable. Depth where the water starts and its vertical component (46), depth where the second aquifer layer starts and its vertical component (47), depth where the third aquifer layer starts and its vertical component (48), point where the water layer ends and its vertical component (49), measuring cable (37), measurement of the concerned depth with the device over the cable (16), layer above the water (50), first aquifer layer (51), second aquifer layer (52), third aquifer layer (53), impermeable layer (54), measuring nail (36), above ground (40), fault line (30).

FIG. 22 shows schematic view of detection of the ground water which is in the form of a pond. Ground water reservoir (55), boundaries of the ground water reservoir (56), starting depth of the ground water reservoir (57), thickness of the first aquifer layer (58), thickness of the second aquifer layer (59), measuring nail (36).

FIG. 23 shows schematic view of detection of the underground rivers. Boundaries of the underground river (60), measuring cables (37), direction rod or nail (61), direction tray (62), measuring nail (36), depth at which underground river flows (63), depth of the underground river (64), measurement of the flow rate of the river (16), measurement of the current in the flowing direction of the river (16), direction of the underground river (65), direction test (66).

FIG. 24 shows schematic view of direction finding in earthquake measurements. Fault line (30), direction nail or rod (61), direction tray (62), measuring cable (37), measurement with the device (16), north (N).

FIG. 25 shows an example of current—time graphic related to single earthquakes. Period (67) provides information regarding the distance of the place where the earthquake starts from the point where the measurement is made, (68) is the time of the earthquake, (A1) is the current proportion determining the magnitude of the earthquake.

FIG. 26 shows an example of current—time graphic related to single earthquakes. Period until when the current remains constant the first time (67), time of the main shock of the earthquake (68), the current proportion determining the magnitude of the earthquake (A1).

FIG. 27 shows an example of current—time graphic related to single earthquakes. Period until when the current remains constant the first time (67), time of the earthquake (68), the current proportion determining the magnitude of the earthquake (A1).

FIG. 28 shows an example of current—time graphic related to sequential earthquakes.

FIG. 29 shows schematic view of detection of mines. Boundaries of the ore lens (head) (69), measuring cable (37), depth of the mine (70), thickness of the mine lens (71), measurement of the current of the mine (16), measuring nail (36).

FIG. 30 shows schematic view of measurement of currents of the moon, sun, stars, planets and galaxies. The conductive nail or rod (61) targeting the celestial body to be measured (16), various antennas (72, 73 and 74) that can be connected in place of the conductive nail or rod (61).

FIG. 31 shows schematic view of detailed examination performed on planets and similar structures. Targeting nail (61), measuring cable (37), telescope (75), planet (76), measurement of the current of the targeted point (16), wide diameter scan disc (77), computer controlled activation system (78).

FIG. 32 shows use of the device as radar. Measuring cable (37), measuring nail or antenna (61), activation system (79), measurement means of the device (16), flying object (80), semispherical conductive antenna (81).

FIG. 33 shows a second application as radar. Measuring cables (37) connected to nails, stakes (82), nails connected to stakes (61), measuring rods (15), flying object (80), conductive rod placed at a far hill (83).

FIG. 34 shows determination of the shapes of the waves flowing over the cable. Points where the rods intercross (15), measuring nail (36), measuring cable (37), the depth at which water starts (86), the depth at which water ends (87), wave curve which connects the points where the rods intercross (84), line of the vertical wave screen of the underground horizontal water layer (85).

FIG. 35 shows shapes of some waves detected at the water level at the vertical component of the experiment well. Waves No. 1 (88), Waves No. 2 (89), Waves No. 3 (90), Waves No. 4 (91), measuring cable (37), upper level of the water layer (86), lower level of the water layer (87).

FIG. 36 shows examination of the vertical wave screen upon bringing it to horizontal position. Points where the rods intercross (15), measuring cables (37), nails disposed perpendicular to the wave screen (61), nail driven at the entrance of the well (36), wave screens (92), examination of the wave screens in horizontal position (93), wooden stakes (82), measurement of the current of the wave over the wave line (16), axis of the rupture wave that intersects the horizontal wave perpendicularly (94), intercrossing of the rods above the wave at the point where there is the wave of the vertical rupture (15).

FIG. 37 shows full shape of the waves. Measuring cable (37), horizontal axis (95), vertical axis (96), horizontal component of the wave (97), vertical component of the wave (98).

FIG. 38 shows the shapes of waves of the horizontal water layer at the 16th meter of the experiment well. Cable (37), axis of the horizontal water layer (95), horizontal waves (99 and 100).

FIG. 39 shows the wave shape of gold. Golden bracelet (101), cable (37), horizontal axis (95) of the golden bracelet perpendicular to the cable, gold wave (102).

FIG. 40 shows the shape of the graphite wave. Graphite sample (103), measuring cable (37), horizontal axis (95) of the graphite sample perpendicular to the cable, graphite wave (104).

FIG. 41 shows the shapes of nested waves produced by substances like wool, rubber, satin and by human brain. Cable (37), measured sample (105), sample axis (95), width at which the waves are arranged (106).

FIG. 42 shows the shape of the wave of pomegranate tree (107). Measuring cable (37), horizontal axis of the tree (95).

FIG. 43 shows the shapes of the waves of diesel (Euro Diesel). Measuring cable (37), horizontal axis of the sample (95), diesel sample (108).

FIG. 44 shows the shapes of the waves produced by water flowing from a faucet. Measuring cable (37), faucet (109), measuring nail (36), linear DC current waves (110), intermittent DC current waves (111), horizontal axis of the nail (95).

FIG. 45 shows the shapes of the waves of the big passenger airplane (112) detained within the cable. Measuring cable (37), horizontal axis of the nail (95), isolated measuring nail (61).

FIG. 46 shows schematic view of obtaining big waves. Measuring cables (37), wave origin (113), first wave forming over the sample (114), second wave obtained by interference of waves (115), third wave obtained by interference of waves (116), stakes (82), measuring nails (61), first point where the cables are connected (117), second point where the cables are connected (118).

FIG. 47 shows various examples of measuring rods and bows. Winding of coils around a ring (119), winding of coils around a disc (120), different shape of the measuring bow (121), flat shape of the rod (122), windings of coil wires (3).

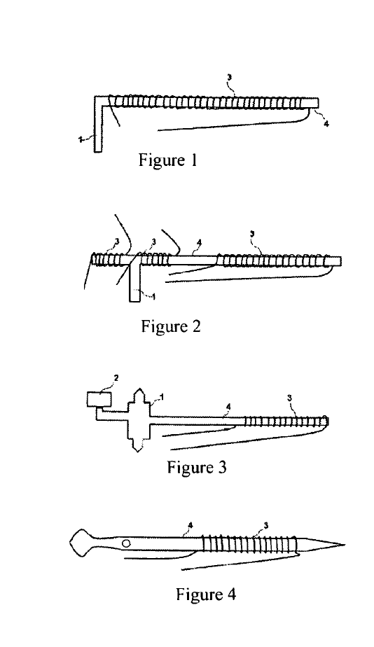

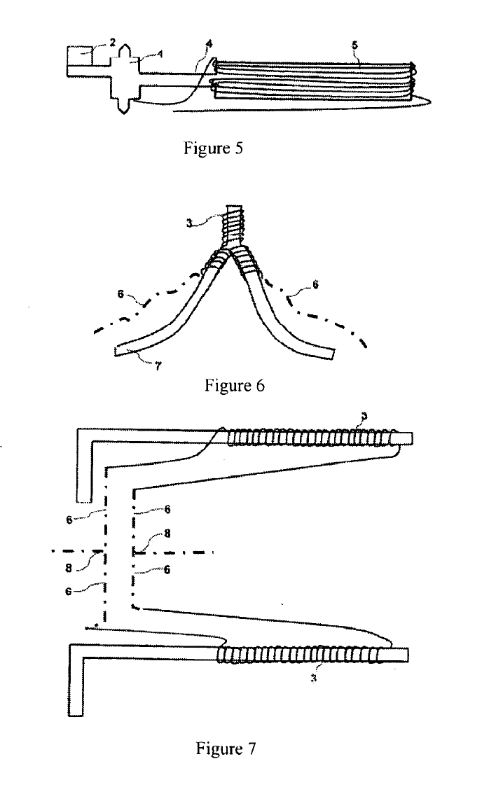

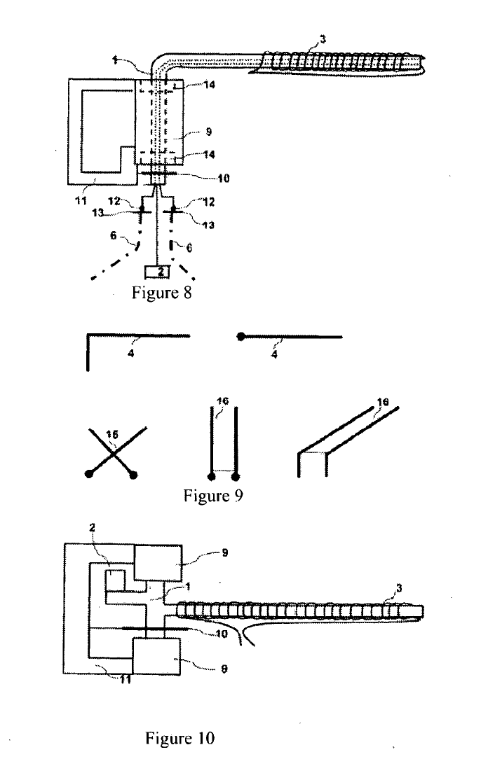

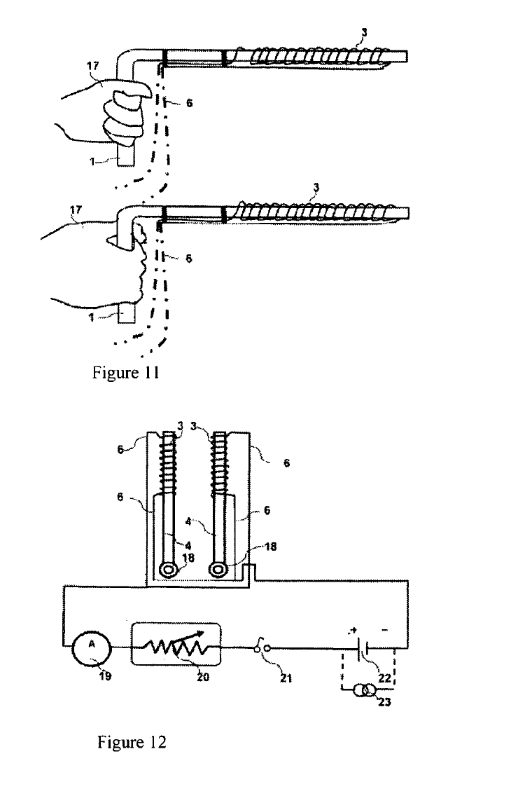

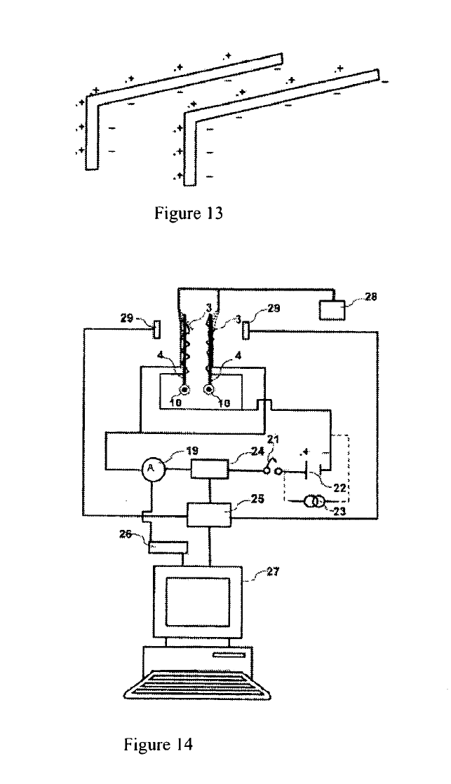

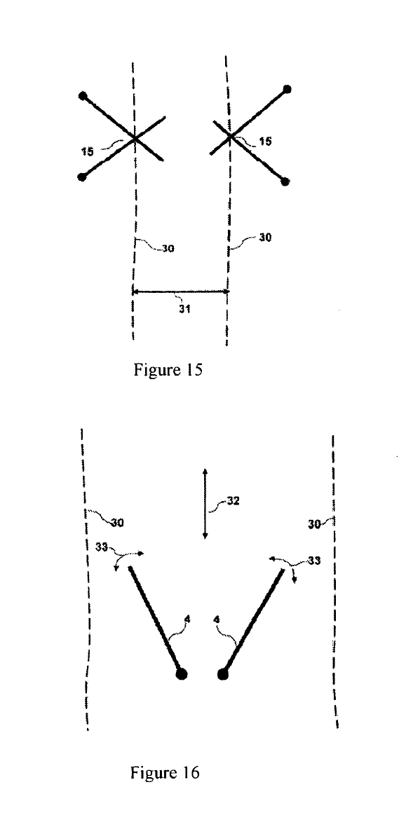

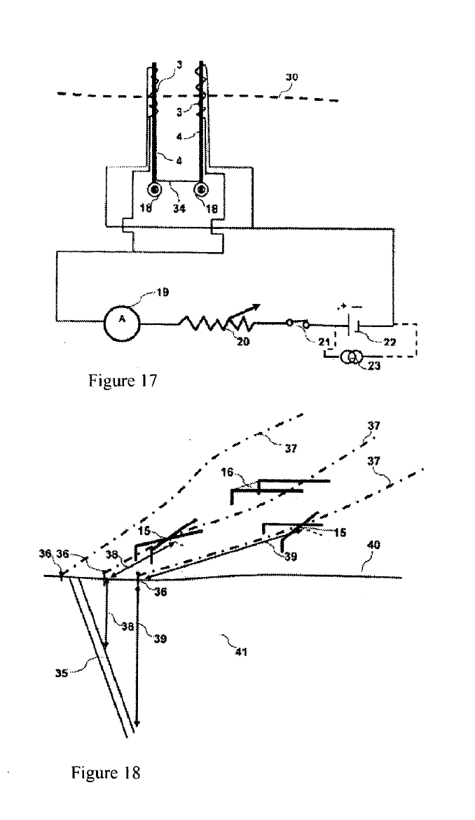

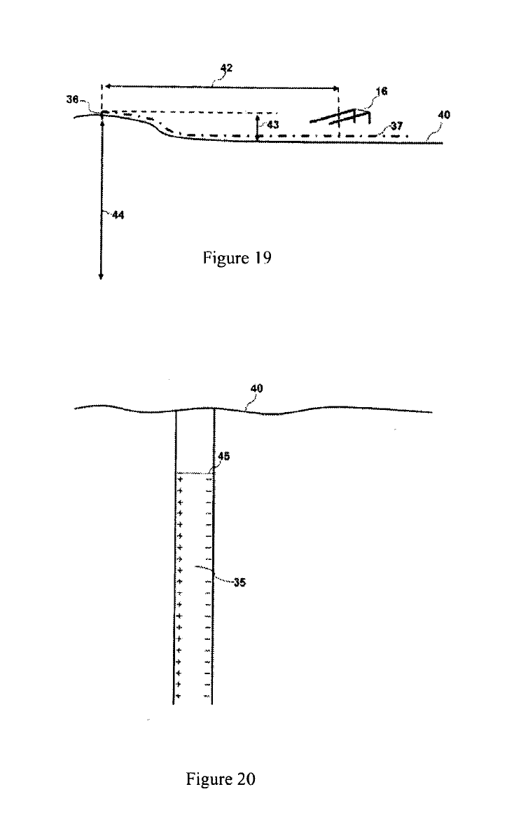

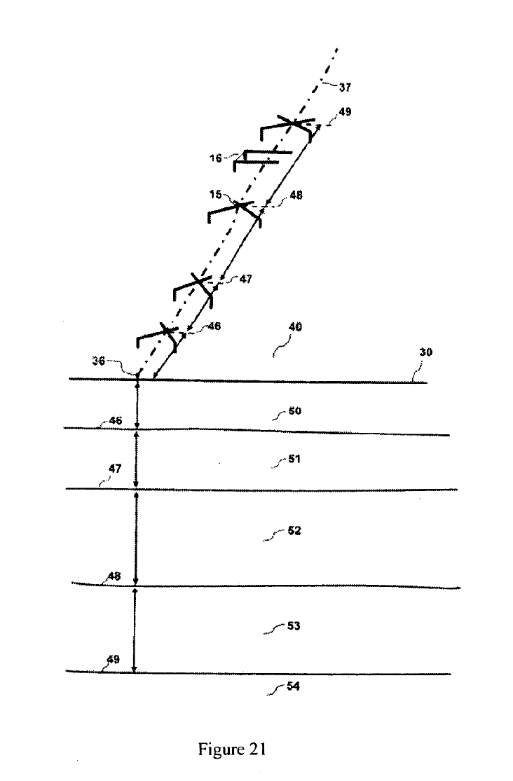

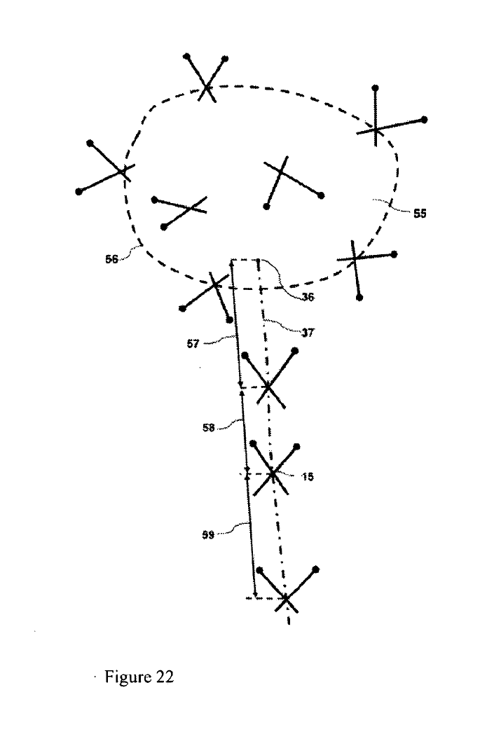

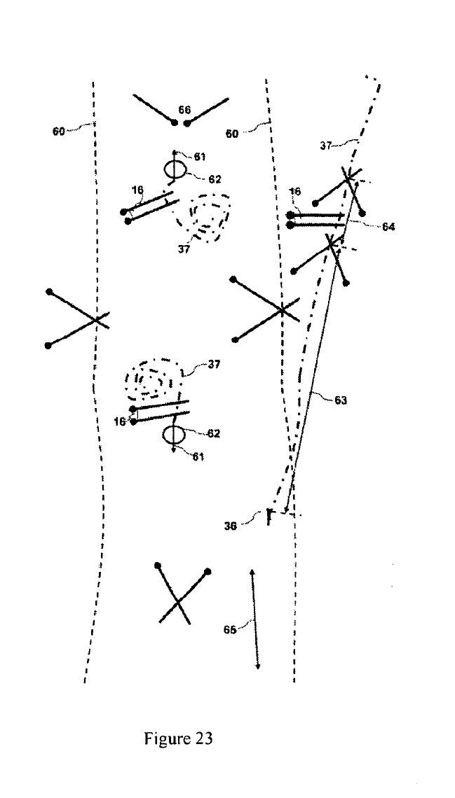

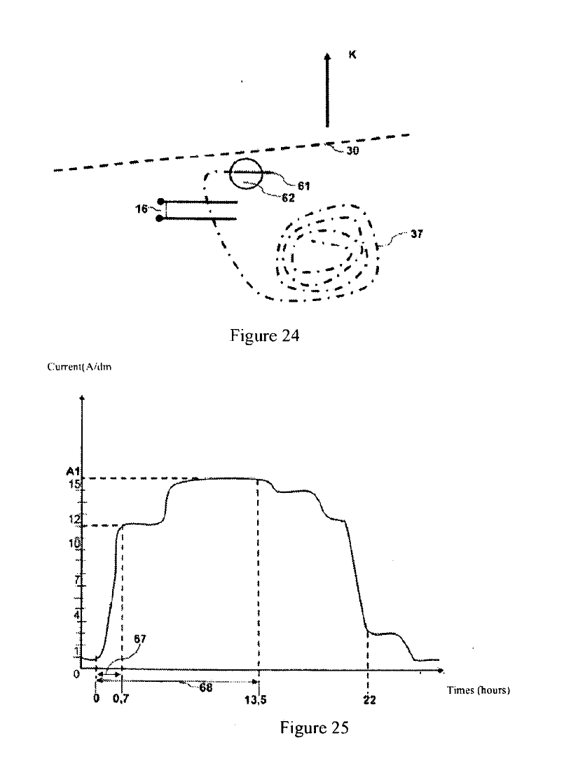

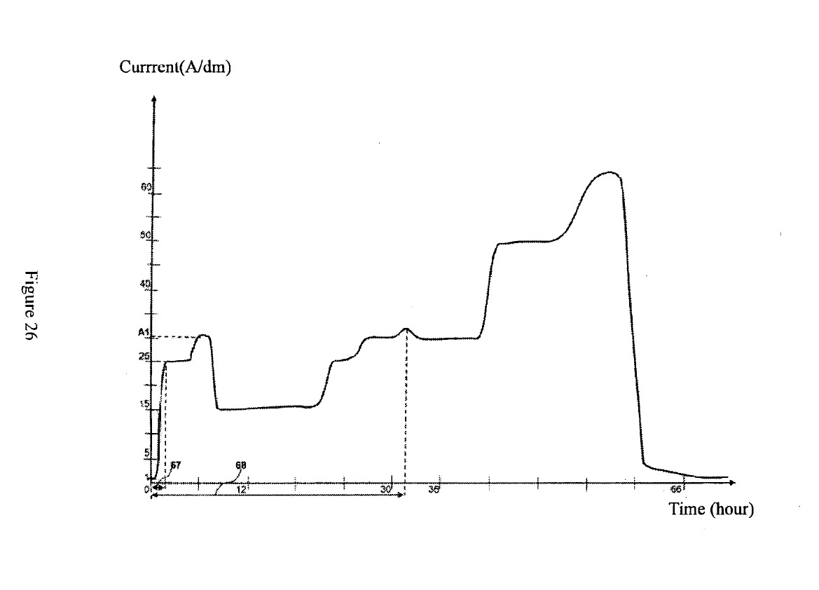

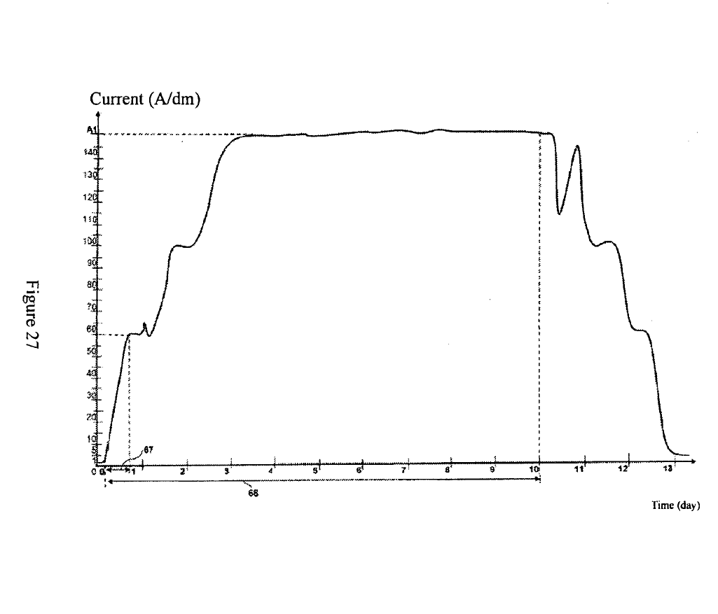

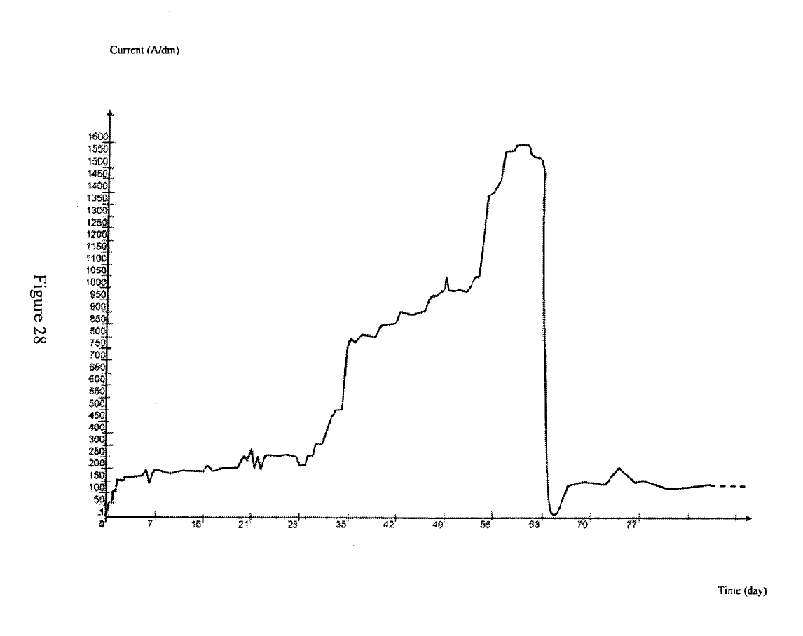

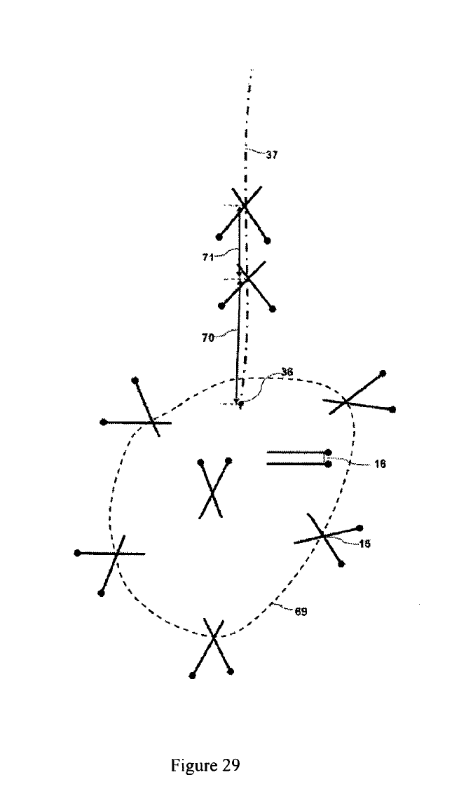

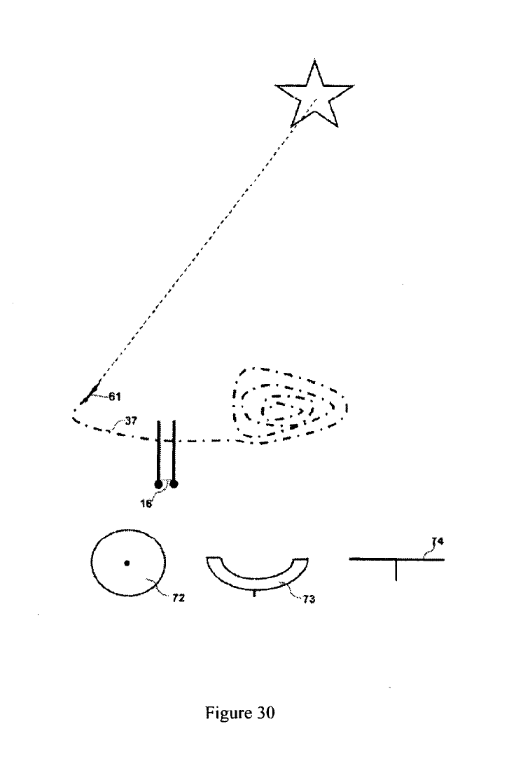

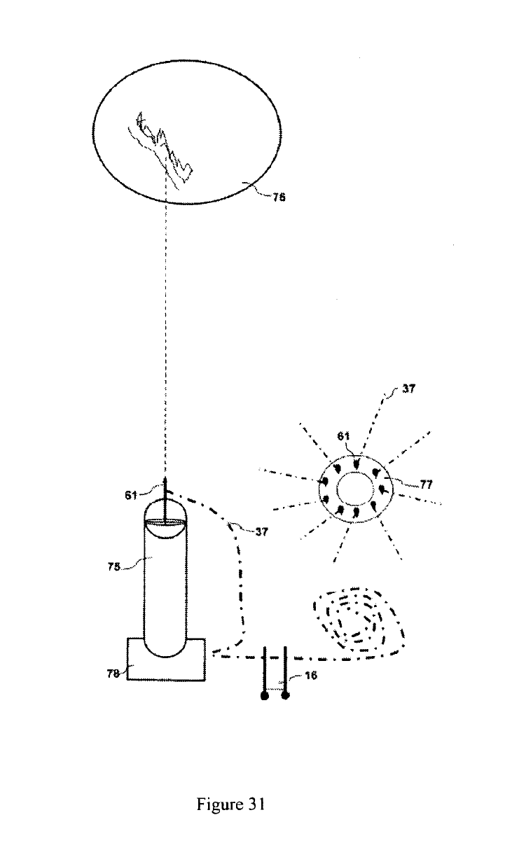

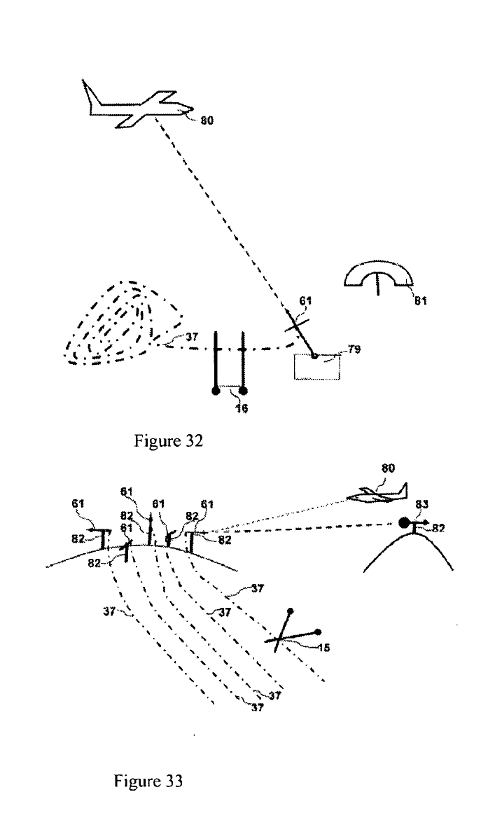

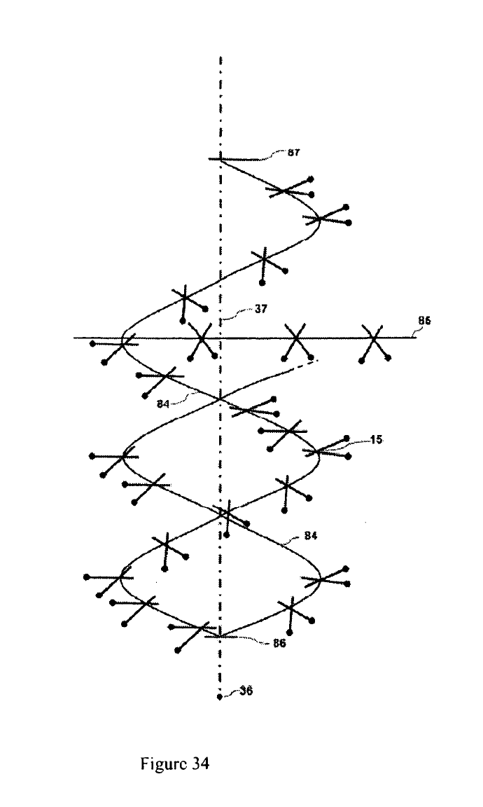

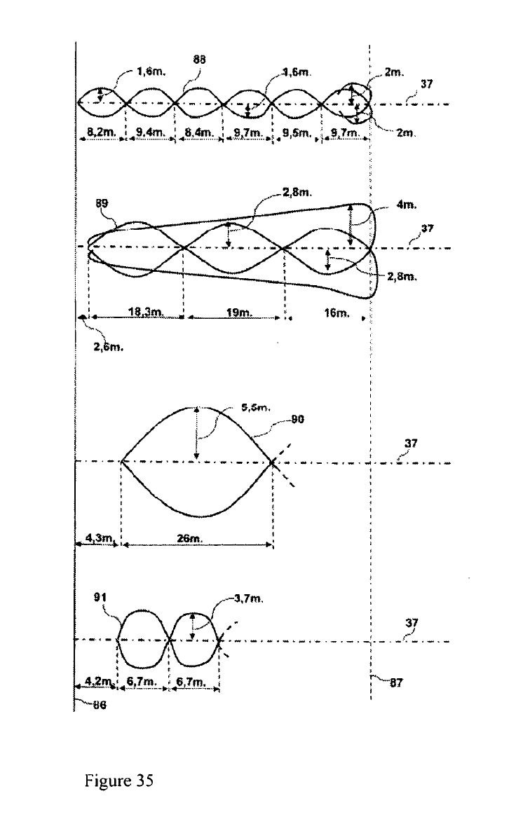

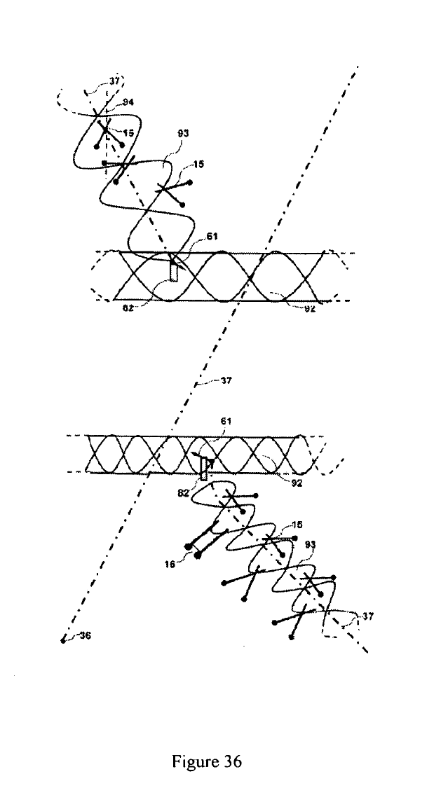

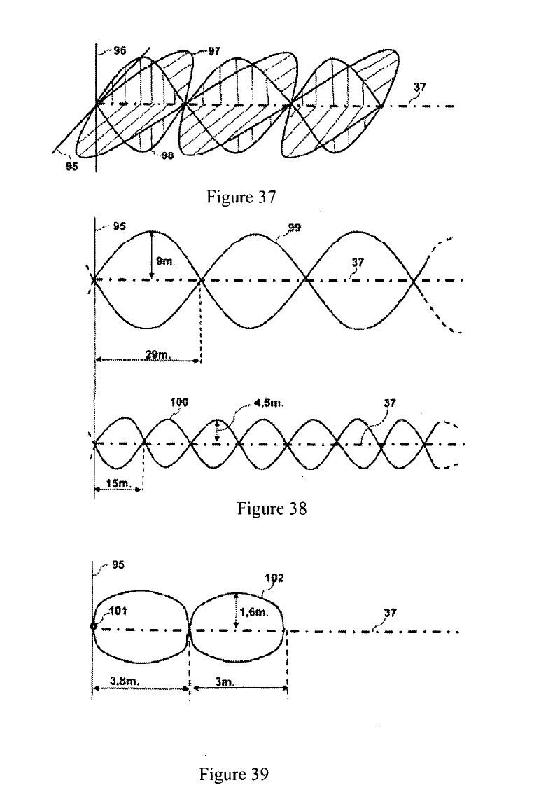

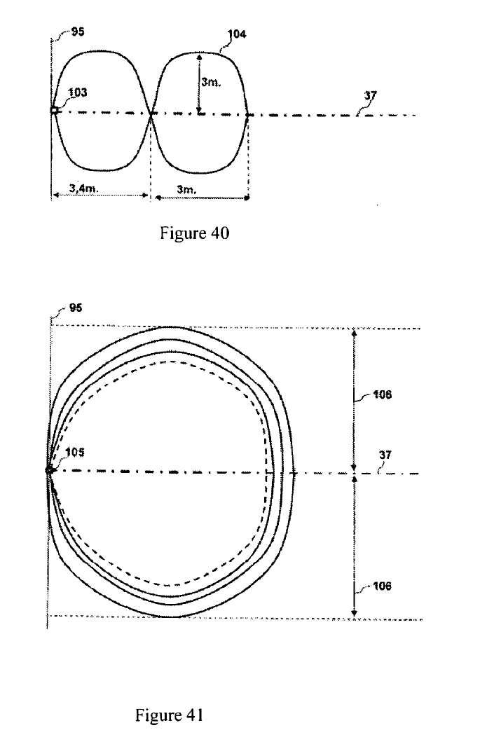

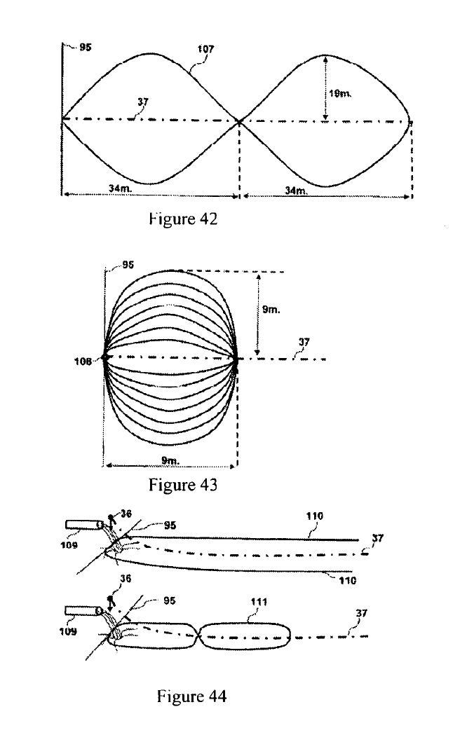

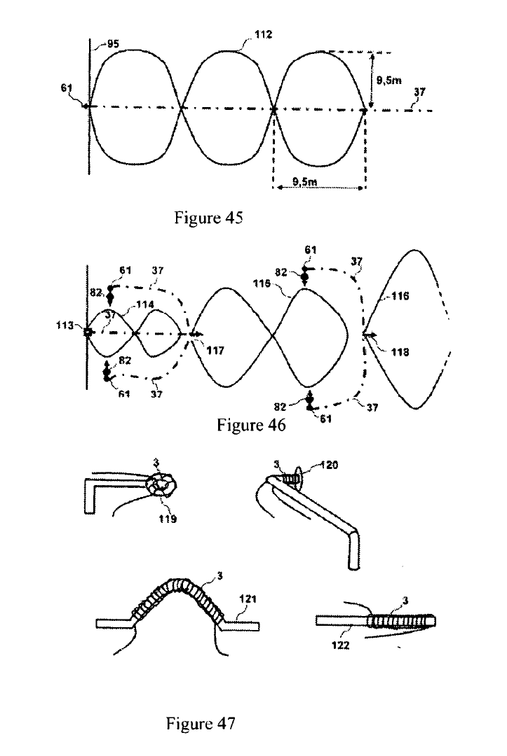

1-38. (canceled)

39. A detection device for measuring currents of planets, moon, sun, stars, galaxies, super novas and black holes, whereby determining electrical and magnetic fields thereof and searching traces of water and life in planets and galaxies; determining wave shapes and detecting wave features of celestial bodies; diagnosing and treating diseases and elucidating structures of the internal organs by measuring the energy of human brain and body and determining the wave models thereof; capturing the electrical and magnetic waves produced by air, land and sea vehicles by being used as radar; detecting the components within the chemical composition of minerals, rocks and various substances and elucidating chemical bond structures of organic compounds; measuring current values of plants; measuring currents of fires and flames; examining the structure of the underground in three dimensions; detecting geological faults, underground waters, mines and oil reservoirs; predicting and detecting earthquakes; producing artificial earthquake waves; destroying earthquake waves by sending counter waves; using the waves emitted by living creatures for communication purposes; characterized by measuring rods and tools (4) rotatable around their own axes, flat measuring rods and tools (122), measuring bow and tools (7, 121), coil wires (3, 5) wound around rods (4, 122) and bows (7, 121), ammeter (19), current controllers (20), on/off switch (21), power supplies (22, 23), measuring cables (37) and nails (36), measuring hose which is filled with water and connected to the measuring nail (36) with a conductor, direction tray (62), bearings (9, 18) for rods, counterweights (2), spring and pendulum (10), conductive coal rods (12), conductive tray (13), connection cables (6), assembly stand and table (11) and magnets.

40. The detection device according to claim 39, for measurement in fixed stations, characterized in that it comprises an automatic current controller (24), sensors (29), a programmable electronic brain (27), an electronic circuit (26) which transfers the current values measured by the ammeter to the computer, a computer (27), a printer connected to the computer and a coil cooling system (28).

41. The detection device according to claim 39, for detailed examination of celestial bodies such as moon, planets, stars, sun, galaxies; characterized in that it comprises a telescope (75); target nails and rods (61, 83); broad (72), wire (74) and dish shaped (73) antennas; wide diameter scanning disc (77) and activation systems (78) for the telescope, antennas and scanning disc.

42. The detection device according to claim 39, characterized in that the measuring rods and bow (4, 7, 121, 122) are made of materials that have the feature of electrification.

43. The detection device according to claim 39, characterized in that the measuring rods and bow (4, 7, 121, 122) are made of any kind of metal and metal alloys.

44. The detection device according to claim 39, characterized in that the measuring rods and bow (4, 7, 121, 122) are made of graphite.

45. The detection device according to claim 39, characterized by measuring cables and hose (37) which, upon being adjusted in a length that will allow sensing the distance until the core of the earth, elucidate the in-depth geological, geochemical, electrical and magnetic structure of the earth by measuring the currents that stabilize the waves coming from the earth and the electrical and magnetic fields produced by these waves, determining the wave shapes and identifying the wave features.

46. The detection device according to claim 39, characterized in that the measuring cables which are connected to the nails directed to the peak points of the waves are connected to each other or the measuring cables (117, 118) connected to different samples are connected to each other for obtaining big waves from small waves.

47. The detection device according to claim 39, characterized by magnets which are connected to the rods (4, 122) such that they will repel each other and which are added and removed, in order to stabilize the force of the magnetic field of the objects to be measured.
